(19) United States
(12) Patent Application Publication
(10) Pub. No.: US 2025/0188100 A1
(43) Pub. Date: Jun. 12, 2025

(54) SILA-ADAMANTANE STRUCTURES, DEVICES, AND METHODS

(71) Applicant: The Regents of the University of California, Oakland, CA (US)

(72) Inventors: Timothy A. Su, Claremont, CA (US); Timothy c. Siu, Temple City, CA (US); Mario Imex Aguirre Cardenas, Pasadena, CA (US); Jacob Seo, Riverside, CA (US)

(21) Appl. No.: 18/843,244

(22) PCT Filed: Mar. 14, 2023
(86) PCT No.: PCT/US2023/015217

§ 371 Date: Aug. 31, 2024

Related U.S. Application Data
(60) Provisional application No. 63/320,201, filed on Mar. 15, 2022.

(51) Int. Cl. C07F 7/21; H01M 4/38

(52) U.S. Cl. CPC C07F 7/21; H01M 4/386

(57) ABSTRACT

Described herein are molecules, materials, devices, and associated methods with respect to functionalized sila-adamantane molecules. The functionalized sila-adamantane molecules can be used as building blocks for larger devices, including but not limited, to electronic devices. Functionalization allows for molecular scale control of a device structure.

### CLAIM OF PRIORITY

This patent application claims the benefit of priority to U.S. Provisional Patent Application Ser. No. 63/320,201, entitled “Sila-Adamantane Structures, Devices, and Methods,” filed on Mar. 15, 2022, which is hereby incorporated by reference herein in its entirety.

### TECHNICAL FIELD

Embodiments described herein generally relate to sila-adamantane materials, devices that utilize sila-adamantane materials, and associated methods.

### BACKGROUND

Silicon based materials possess several useful properties, including, but not limited to, semiconductivity. Electronic devices utilizing silicon based material are often desired at increasingly small scales, such as nanoscales. Silicon based materials can be useful for a number of other applications when functionalized for a specific property. It is desired to have specifically tailored silicon based materials that address these concerns, and other technical challenges.

### BRIEF DESCRIPTION OF THE DRAWINGS

FIG. 1 shows (a) Roadmap to the development of adamantane-based molecules & materials. (b) Marschner's isomerization of 1 to SiAd 2 via aluminum chloride. (c) This work develops the chemistry to regioselectively functionalize sila-adamantane at its 1-, 2-, 3-, 5-, & 7-positions, providing the next stepstone toward functional silicon diamondoid molecules & materials. in accordance with some example embodiments.

FIG. 2 shows (top) Chemical structures of the 2-functionalized 3 and 1,3,5,7-functionalized 4 and 5, with functional groups highlighted. (bottom) Molecular structures as determined by single-crystal X-ray diffraction. Thermal ellipsoids plotted at 50% probability for 3 and 5 and 30% probability for 4. Solvent molecules and H atoms omitted for clarity.

FIG. 3 shows (a) ¹H NMR spectra of reaction aliquots for a representative isomerization of 1 with AlCl₃ track the presence of 1, 2, 3, and 6 over the reaction timecourse. Asterisk (*) at 24 h timepoint denotes tetramethylsilane generated in situ. (b) 2-cation 7 is 10.2 kcal/mol lower in free energy (ΔG²⁹⁸) than exo-cation 8 based on gas-phase DFT calculations at the M06-2X/6-311G+(d,p) level of theory. Red-colored bonds indicate Si—Si bonds that are coplanar with the silylium 3p orbital. Scheme illustrates proposed pathways for the generation of 2, 3, and 6. (c,d) Proposed pathways to explain product distribution in the isomerization of 1 with (c) AlCl₃ or (d) AlCl₃—SiMe₃Cl. Bottom plots show percent yield against reaction time, with yields determined from ¹H NMR spectra of reaction aliquots against cyclohexane or tetradecane internal standards.

FIG. 4 shows i) KO^{t}Bu (1.0 equiv.), 18-crown-6 (1.0 equiv.), toluene. ii) electrophilic reagent. ^{a}Isolated yields. Reactions executed on 0.05-0.2 mmol scales.

FIG. 5 shows (a) One-pot functionalization schemes to access di-, tri-, and tetra-functionalized sila-adamantane with methylthiomethyl groups. i) potassium tert-butoxide (2 equiv.), 18-crown-6 (2 equiv.), toluene; chloromethyl methyl sulfide, 14% yield. ii) potassium tert-butoxide (3 equiv.), 18-crown-6 (3 equiv.), toluene; chloromethyl methyl sulfide, 28% yield. iii) potassium tert-butoxide (4 equiv.), 18-crown-6 (4 equiv.), toluene; chloromethyl methyl sulfide, 36% yield. (b) Molecular structure of dianion 22 as determined by single-crystal X-ray diffraction, with thermal ellipsoids plotted at 50% probability. Solvent molecules and H atoms omitted for clarity. Si (blue), C (black), O (red), K (purple). (c) Sequential tetra-functionalization scheme to install four unique reagents. i) potassium tert-butoxide (1 equiv.), 18-crown-6 (1 equiv.), toluene; p-toluenemethanesulfonate, 97% yield. ii) potassium tert-butoxide (1 equiv.), 18-crown-6 (1 equiv.), toluene; chlorotriisopropylsilane, 44% yield. iii) potassium tert-butoxide (1 equiv.), 18-crown-6 (1 equiv.), toluene; chloromethyl methyl sulfide, 71% yield. iv) potassium tert-butoxide (1 equiv.), 18-crown-6 (1 equiv.), toluene; dibromoethane, 96% yield.

FIG. 6 shows a flow diagram of a method of forming a functionalized sila-adamantane material in accordance with some example embodiments.

FIG. 7 shows a diagram of a sila-adamantane molecule, in accordance with some example embodiments.

FIG. 8 shows an electronic device that may incorporate a functionalized sila-adamantane material, in accordance with some example embodiments.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The present disclosure describes the site-selective functionalization of sila-adamantane, the fundamental silicon diamondoid nanocluster that is isostructural with the crystalline silicon unit cell. The synthesis of this material occurs through the Lewis acid isomerization of a strained, tricyclic oligosilane. Here, we provide experimental support that a silylium-like ion is generated at the 2-position of sila-adamantane as the final isomerization intermediate; the deliberate removal of methyl donors from the reaction medium allows us to hijack the isomerization pathway and install halides at the 2-position of the cluster. Next, we show that sila-adamantane may be functionalized at its 1-, 3-, 5-, and 7-positions in a single-pot reaction with the same functional group, or sequentially with unique functional groups. These methods enable the regioselective functionalization of sila-adamantane at five distinct centers within the sila-adamantane core, opening the use of sila-adamantane as a building block for ligand scaffolds, electronic and optical devices, and extended silicon diamondoid-based materials.

### INTRODUCTION

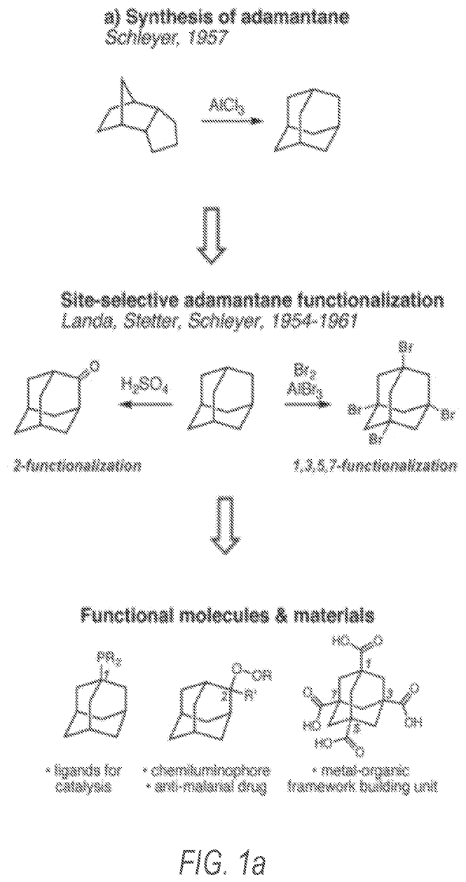

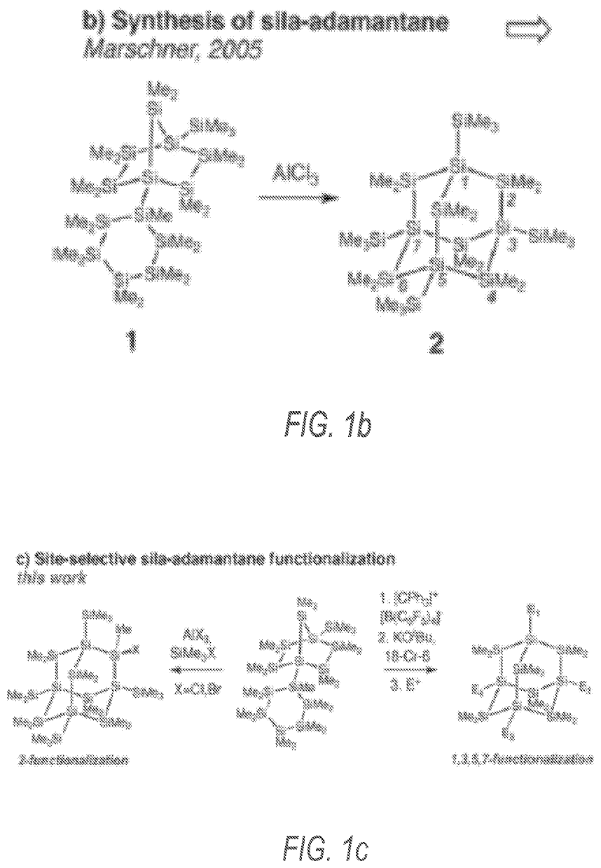

The following describes the regioselective functionalization of sila-adamantane at five discrete silicon centers within its cluster core. Sila-adamantane (SiAd) is the fundamental silicon diamondoid cluster that is isostructural with the crystalline silicon unit cell. It bears particular intrigue in the context of nanoscale electronics, as it represents the ultimate limit of miniaturization. for crystalline silicon, the defining semiconductor material of our modern era. Fischer, Baumgartner, and Marschner reported the first and only synthesis of sila-adamantane in 2005 (FIG. 1a, 1b). Using rational Si—Si bond-forming reactions, these authors synthesized a strained, tricyclic oligosilane 1 that rearranges to its tricyclic sila-diamondoid isomer 2 upon treatment with the Lewis acid aluminum chloride, akin to Schleyer's Lewis acid-catalyzed isomerization synthesis of carbon adamantane (FIG. 1a, 1b). Strain release and the generation of quaternary Si centers at the 1-, 3-, 5-, and 7-positions provide the driving force for the isomerization of 1 to SiAd 2, with 2 being 27.0 kcal/mol enthalpically downhill from 1 (DFT calculations at M06-2X/6-311G+(d,p) level, Supplementary Information). Since Marschner's landmark single-page report, there have been no follow up experimental studies on this intriguing material, leaving much to be discovered about the mechanism of its synthesis, derivatization, and physical properties.

While adamantanes with mixed tetrel-silicon cores such as C₆Si₄ adamantane (carborundane) and recent GeₓSi_{y} adamantanes have been reported, the development of silicon diamondoids as a material class remains in its infancy, particularly when juxtaposed against their carbon-based congeners. Carbon adamantane exhibits a number of desirable properties such as high rigidity, thermal and chemical stability, steric bulk, electron richness, hydrophobicity, and strong dispersion effects; however, the unsubstituted C₁₀H₁₆ carbon adamantane itself has limited applications of use. The development of synthetic methods to site-selectively functionalize carbon adamantane at its secondary 2-position and tertiary 1-, 3-, 5-, and 7-positions allowed chemists to exploit the unique advantages of adamantane by incorporating it into functional molecules and materials. The derivatization of carbon adamantane at these positions has enabled its use in therapeutics, bioimaging probes, ligands for organometallic catalysts and nanomaterials, polymers, and framework materials (FIG. 1a)

Sila-adamantane shares many of the desirable properties of carbon adamantane. It is air- and moisture-stable, tetrahedral, rigid, unstrained, and possesses high thermal stability. Crucially, sila-adamantane should demonstrate even stronger dispersion interactions, electron-donating abilities, and electronic delocalization relative to carbon adamantane due to the much stronger σ-conjugation and bond polarizability found in Si—Si and Si—C bonds relative to C—C bonds. The site-selective functionalization of sila-adamantane may thus lead to the incorporation and use of silicon diamondoids in functional molecules and materials across broad areas of use.

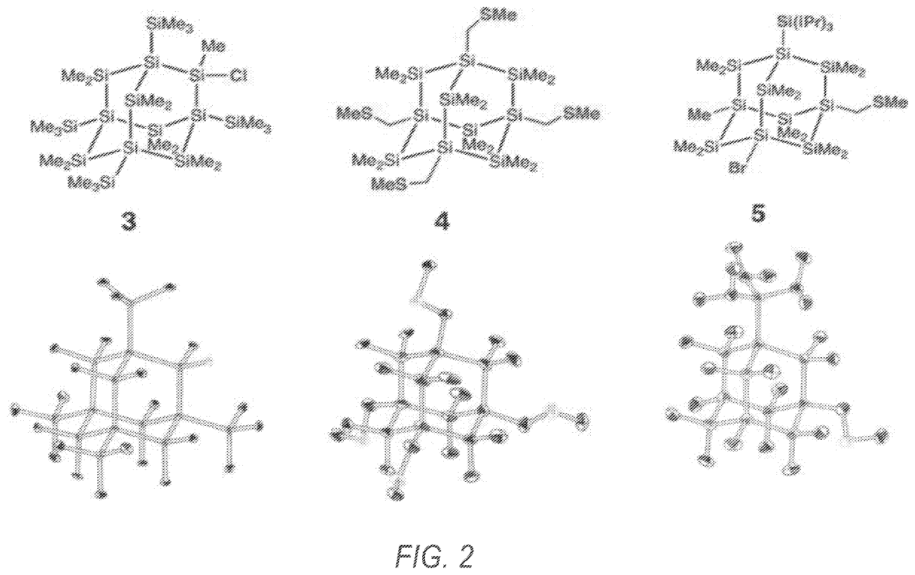

The present disclosure describes the site-selective functionalization of sila-adamantane at its 1-, 2-, 3-, 5-, and 7-positions (FIG. 1c). We provide experimental support that a silylium-like ion is generated at the 2-position in the penultimate step of the Lewis acid isomerization of 1; the removal of methyl donors from the reaction medium enables us to install halides at the 2-position, as exemplified by 2Cl—SiAd 3 (FIG. 2). Next, we show that the silanide of 2 reacts with a broad panel of electrophilic reagents to yield mono-functionalized sila-adamantane clusters. We can extend this approach to tetra-functionalize sila-adamantane at its 1-, 3-, 5-, & 7-positions with the same functional moiety in a single-pot reaction as in 4 (FIG. 2), or with four unique functional groups in sequential steps as in 5 (FIG. 2). We anticipate that the reported functionalization strategies will pave the way to new ligands, materials, and devices that incorporate silicon diamondoids as functional building blocks.

### Results

We were interested in chemically functionalizing sila-adamantane as a key first step to explore the synthesis and quantum transport of atomically precise nanoclusters of the silicon semiconductor. We first set out to reproduce Marschner's synthesis of SiAd 2 and explore its isomerization outcomes in more detail. Precursor 1 (FIG. 1) was synthesized via Marschner's route through a series of polar reactions between potassium silanide nucleophiles and silyl chloride electrophiles (S1, Appendix A). We evaluated the isomerization of 1 to 2 with several Lewis acids including the original aluminum chloride and trityltetrakis(pentafluorophenyl)borate, the latter of which provided cleanest access to 2 (68% yield) on gram-scale.

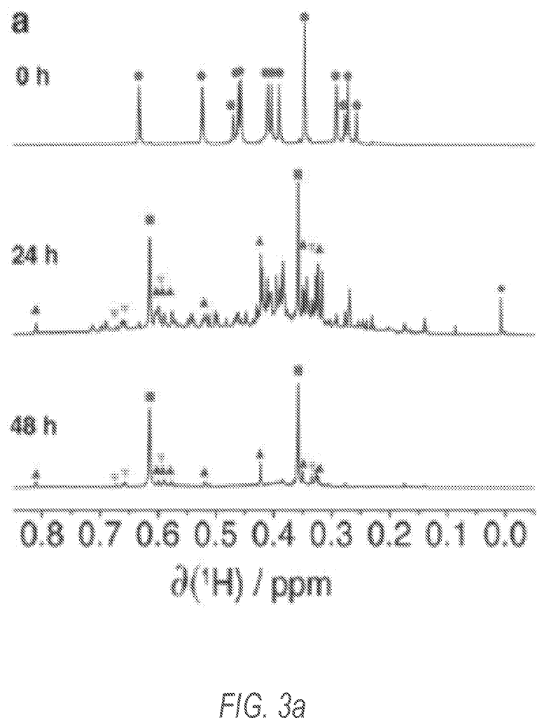

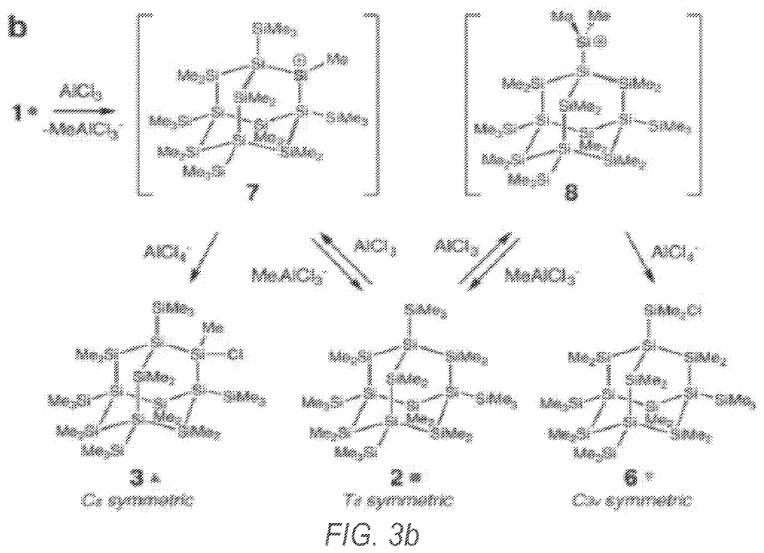

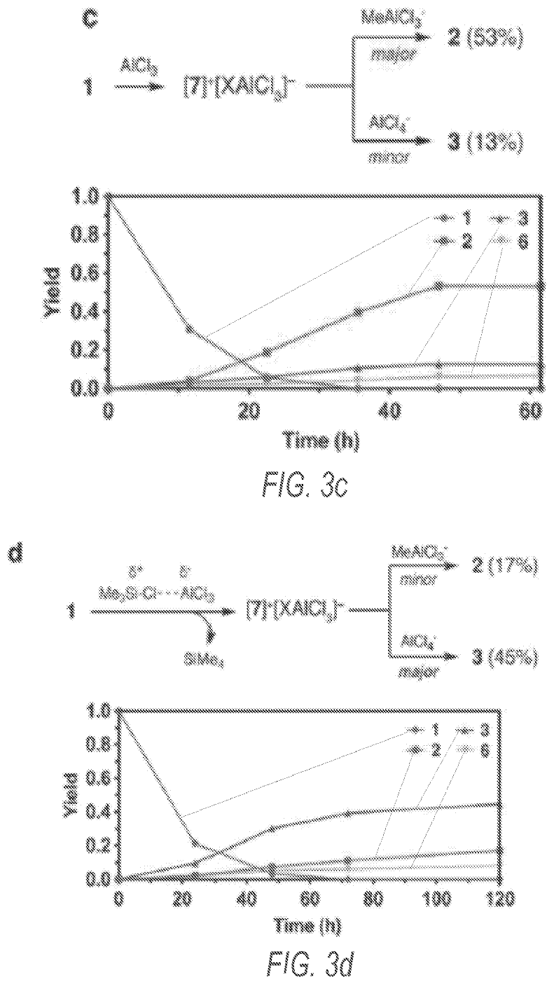

Current methods employ a methyl lithium quench following the isomerization of 1, presumably to methylate the chlorinated byproducts known to arise from the aluminum chloride-mediated skeletal isomerization of oligosilanes. We were interested in identifying and isolating these chlorinated byproducts as a potential route to functionalizing sila-adamantane. FIG. 3a shows NMR spectra of reaction aliquots from a representative isomerization of 1 to 2 via aluminum chloride in benzene. The unmarked peaks at the 24-hour timepoint correspond to unidentified intermediates that form over the course of isomerization. These intermediates largely disappear at the 48-hour timepoint, as they have coalesced into products with silicon adamantane cores, the most prominent of which belongs to the T_{d}-symmetric 2. SiAd 2 forms in 53% yield under these conditions, along with monochlorinated sila-adamantane byproducts that we have assigned as the 2-chlorinated 3 (13% yield) and the exocyclic chlorinated 6 (6% yield) (FIG. 3b, 3c) based on the isolation of 3 from the reaction mixture and the independent synthesis of 6 from 2 (S2, Appendix A). We note that a portion of 2 becomes chlorinated in the presence of aluminum chloride alone under our reaction conditions, leading to a distribution ratio of 2 (94%), 3 (2.6%), and 6 (3.4%) over the same 48-hour reaction period. While this pathway may partially account for the formation of 3 and 6, it does not explain the enrichment of 3 relative to 6 found in the AlCl₃-mediated rearrangement of 1 (FIG. 3c).

We were particularly intrigued by the generation of 3, both for its mechanistic implications and because functionalization at the 2-position is less straightforward compared to the SiAd bridgehead centers. In one example, methyl transfer from 1 to the Lewis acid initiates a cascade of bond shifts to the lowest energy oligosilanyl cationic structure, whereupon methyl transfer from [MeAlCl₃]⁻ to the resulting silylium intermediate terminates isomerization. Under this premise, terminal methylation must occur at a silylium center located at either the exocyclic or 2-position. Gas-phase DFT calculations of the free cation indicate that the 2-cation 7 is 10.2 kcal/mol lower in free energy than the exo-cation 8 (S3, Appendix A), most likely due to the stronger hyperconjugative stabilization from adjacent, coplanar Si—Si bonds (S3, Appendix A). We note that the 2-cation is the final intermediate in the isomerization synthesis of carbon adamantane for analogous reasons. These factors, along with the enrichment of 3 relative to 6, suggest that 2-cation 7 is the favored final intermediate that forms in the isomerization of 1 to SiAd 2 under our reaction conditions.

The evolution of tetramethylsilane over the reaction course, as shown in the ¹H NMR spectrum of the 24-hour timepoint (FIG. 3a), provides a key clue to how the chlorinated sila-adamantane 3 forms. Tetramethylsilane is produced via redistribution reactions in oligosilanes induced by strong Lewis acids. As tetramethylsilane is highly volatile, its evolution from the reaction mixture effectively removes methyl donors from the reaction mixture that would otherwise methylate the 2-cation via [MeAlCl₃]⁻ to yield SiAd 2. Presumably, in the absence of these methyl donors, the final 2-cation may instead be quenched by chloride donation from species such as [AlCl₄]⁻ counterions, leading to the formation of the chlorinated 3 (FIG. 3b). We employed the SiMe₃Cl—AlCl₃ Lewis acid system to probe this hypothesis (FIG. 3d). Previously this system was used to activate the silicon center of the trimethylsilyl chloride as a strong Lewis acid and ultimately obtain chlorinated oligosilane products. Methyl transfer from 1 to the activated SiMe₃Cl—AlCl₃ species leads to the deliberate generation of SiMe₄. Its evolution effectively removes the methyl group that originally came from 1 from the system, enriching the ratio of [AlCl₄]⁻ counteranions that may chlorinate 7 (FIG. 3d). Indeed, inclusion of an equimolar amount of SiMe₃Cl relative to the tricyclic precursor with AlCl₃ yields a 2.7-fold enrichment of 2Cl—SiAd 3 (45% yield) relative to SiAd 2 (FIG. 3d). Treatment of 1 with the SiMe₃Br—AlBr₃ system similarly gives 2Br—SiAd 9, albeit in lower yields. These findings provide indirect support that the 2-cation is the favored final intermediate in sila-adamantane formation; the removal of methyl donors allows us to intercept this intermediate and install halides precisely at the 2-position of the sila-adamantane core. Further derivatization at the 2-position is being investigated in our laboratory.

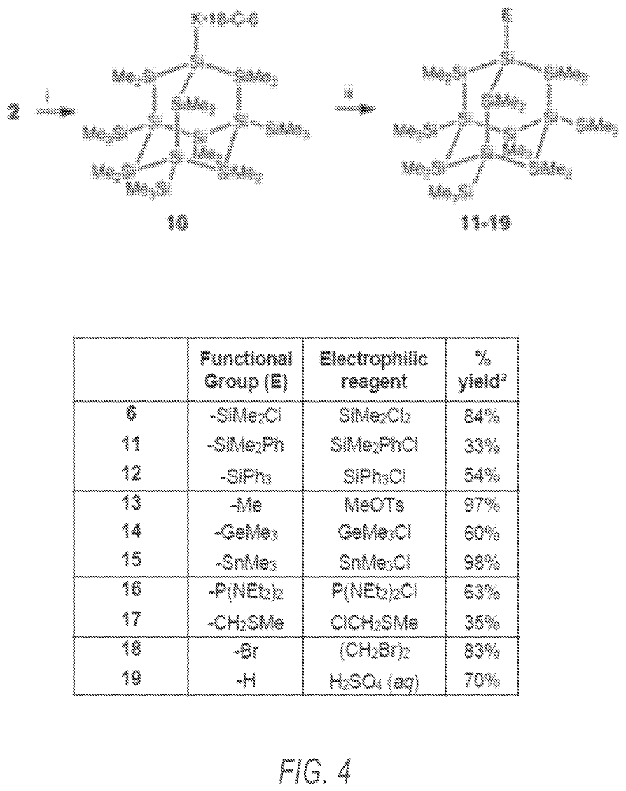

Next, we sought to establish whether SiAd 2 could be functionalized at its bridgehead positions with electrophiles through the selective cleavage of terminal trimethylsilyl groups via potassium tert-butoxide. Reaction of 2 with potassium tert-butoxide gave the sila-adamantyl anion 10 (FIG. 4), which was further reacted with a panel of electrophilic reagents to furnish the mono-functionalized derivatives 6, 11-19 (FIG. 4). 6, 11, and 12 provide reactive exocyclic silicon centers through which SiAd may be attached to more elaborate molecules and materials via nucleophilic substitution. Silyl chloride 6 may be used directly in these contexts, whereas 11 and 12 contain masked reactive sites, as silyl phenyl moieties are readily transformed into reactive silyl triflates or halides upon protodesilylation with strong acids. Beyond silyl substituents, 10 can be functionalized with other tetrel substituents such as alkyl (13), germyl (14), and stannyl (15) groups. Derivatives 16 and 17 contain exocyclic σ-donors that can potentially engage in dative interactions with Lewis acids, metal centers, and electrode surfaces. We find that silyl bromide 18 is inert to displacement by strong nucleophiles like lithium diethylamide, likely due to the electron richness of the cluster and steric protection against backside approach of the σ*_{Si—Br} orbital conferred by the sila-adamantyl cage (S4, Appendix A). We anticipate that silyl hydride 19 may further engage in hydride transfer or abstraction chemistry.

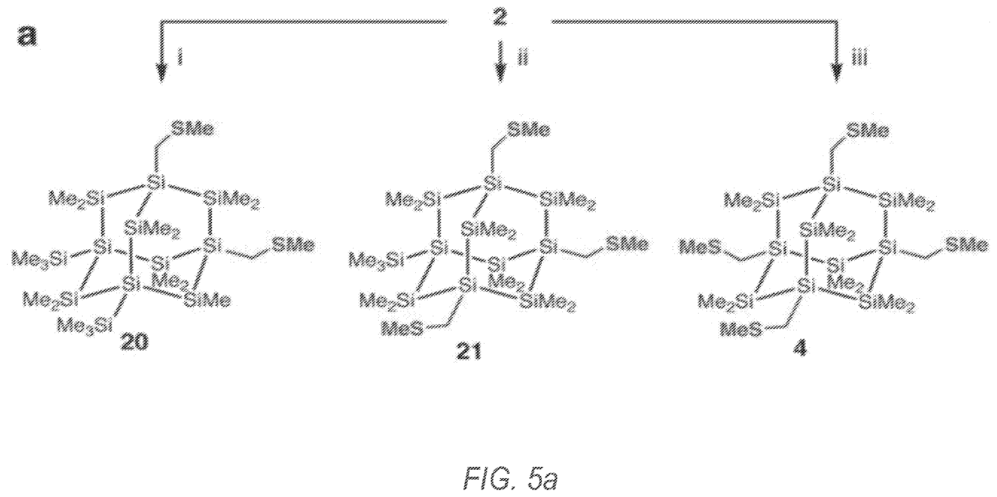

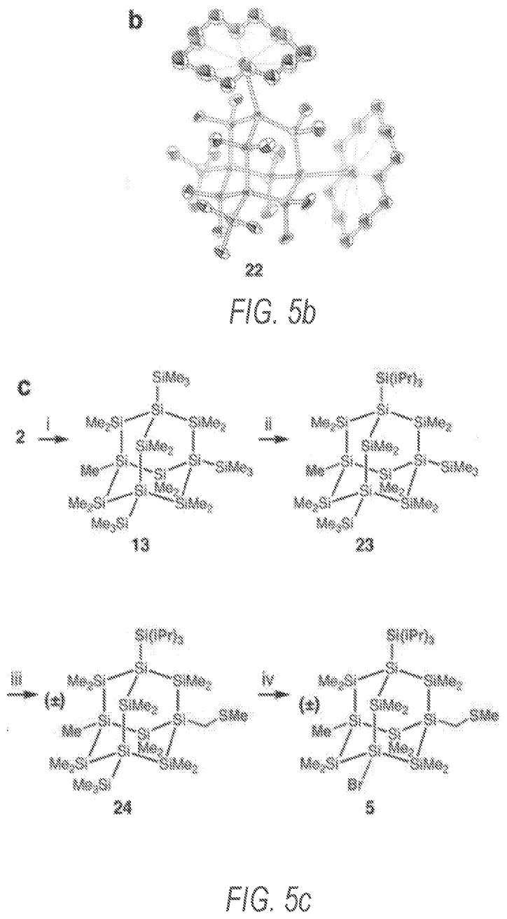

We can tetra-functionalize sila-adamantane at its 1-, 3-, 5-, and 7-positions either in a single-pot reaction with the same electrophilic reagent, or in sequential reactions with four unique functional groups (FIG. 2, FIG. 5). First, treatment of 2 with two, three, or four equivalents of potassium tert-butoxide and 18-crown-6 followed by reaction with a chloroalkane electrophile leads respectively to 1,3-, 1,3,5-, or 1,3,5,7-functionalized sila-adamantanes 20, 21, and 4 (FIG. 5a). To our knowledge, 4 represents the first example of four silanide centers being generated and functionalized in a single-pot reaction. While oligosilanyl dianions are common, trianions are rare and tetraanions have not been reported. We thus sought to characterize the anionic intermediate in the tetra-functionalization reaction. Treatment of 2 with four equivalents of potassium tert-butoxide and 18-crown-6 predominately yields dianion 22 (FIG. 5b). This finding suggests that 21 and 4 are likely made through the sequential generation and quenching of anionic sites on the SiAd cluster. For example, in the synthesis of 4, the dianion 22 is first quenched with the chloroalkane electrophile to yield 20 as a transient intermediate. The excess equivalents of potassium tert-butoxide likely cleave the remaining trimethylsilyl groups for subsequent chloroalkane functionalization to 4. The selective reactivity of potassium tert-butoxide with trimethylsilyl groups over the electrophilic reagent and electrophilic functional group enables this tetra-functionalization chemistry to occur cleanly. We selected the methylthiomethyl functional group in this case because of its established use as a linker group for molecular silicon electronics; however, other functional groups may also be installed in one-pot tetra-functionalization reactions, provided they meet the criteria outlined above.

Finally, we show that the trimethylsilyl centers may also be successively cleaved and functionalized at the 1-, 3-, 5-, & 7-positions with four unique substituents. FIG. 5c shows conversion of the T_{d}-symmetric 2 into the chiral sila-adamantane 5 (FIG. 5) through the successive installation of methyl (13), triisopropylsilyl (23), methylthiomethyl (24), and bromo groups (5) in a 29% overall yield starting from 2. Functional groups that are inert to sila-adamantyl anions and are less reactive than trimethylsilyl groups to potassium tert-butoxide attack are likely to be compatible with this sequential substitution strategy. This synthetic approach opens a path to atomically precise, multifunctional materials that can be grown outwardly from a sila-adamantyl core.

### Discussion

Methods to site-selectively functionalize carbon adamantane at its 2-position via oxidation and 1-, 3-, 5-, & 7-positions positions via ionic bromination enabled the derivatization and use of functionalized adamantanes that are now ubiquitous in catalysts, medicines, and materials. Following this roadmap, the site-selective functionalization of sila-adamantane should serve as the next stepstone from Marschner's synthesis of sila-adamantane to establish silicon diamondoids as functional materials of interest (FIG. 1). This work shows that we can access sila-adamantane on gram-scale, install halides at its 2-position, and functionalize its 1-, 3-, 5-, & 7-positions with electrophilic reagents. Radical and nucleophilic functionalization approaches are currently being investigated in our laboratory. Our 2-functionalization studies implicate the aluminate-stabilized silylium 7 (FIG. 3) as the terminal intermediate in the AlCl₃-mediated rearrangement of 1 to SiAd 2. Direct structural characterization of 7 and the intermediates that precede it will further illuminate the nature of this intriguing rearrangement mechanism.

The tetra-functionalization of sila-adamantane with identical substituents may allow its use as a tetrahedral super atom building block in solid state materials; its functionalization with unique substituents may lead to the creation of multivalent materials with sila-diamondoid cores. Broadly, these substitution strategies open sila-adamantane for potential use in applications that currently rely on the organic adamantane but would find added benefit from the strong polarizability and electronic delocalization of sila-adamantane. This functionalization chemistry may also enable sila-adamantane to be derivatized and incorporated into materials for applications in which silicon is uniquely suited, such as energy conversion, lithium ion storage, and electronic transport. Finally, as sila-adamantane is isostructural with the silicon unit cell, by definition, it may be conceived as the smallest possible silicon nanocrystal. Under this premise, SiAd may serve as a structurally precise model system for studying both the surface reactivity and properties of ultrasmall silicon nanocrystals. The surface structure of silicon nanocrystals is difficult to control and characterize, yet it dominates silicon nanomaterial properties.^{62,63} Our methods allow the periphery of silicon diamondoids to be precisely modified and controlled, opening opportunities for studying how the surface structure of silicon nanocrystals dictates its resulting physical properties in an atomically exact fashion.

### Synthetic Procedures and Characterization of Compounds

### General Synthesis and Characterization Information

All reactions were performed in oven-dried or flame-dried glassware, unless otherwise stated. Reaction vessels were fitted with Teflon magnetic stir bars and rubber septa and reactions were conducted under nitrogen or argon on a Schlenk manifold or in a nitrogen-filled glovebox. Reaction solvents were purged with argon and dried over activated alumina columns through a JCMeyer solvent purification system, then stored over 4 Å molecular sieves. Automated flash chromatography was performed using a Yamazen Smart Flash AKROS system with Yamazen Premium silica columns.

Materials. All chemicals were purchased from commercial sources and used without further purification unless otherwise stated. 1 was synthesized according to procedures adapted from the literature. Trityl tetrakis(pentafluorophenyl)borate was purchased from Aaronchem or Strem, aluminum chloride (99.999%) was purchased from Sigma Aldrich, unless otherwise stated.

Instrumentation. ¹H NMR, ¹³C NMR and ²⁹Si NMR were recorded on Bruker NEO 400 (400 MHz) or Bruker AV 600 (600 MHz) spectrometers. Chemical shifts for ¹H NMR are reported in parts per million downfield from tetramethylsilane and are referenced to residual protium in NMR solvents (CHCl₃, δ 7.26; C₆H₆, δ 7.16). Chemical shifts for ¹³C NMR are reported in parts per million downfield from tetramethylsilane and are referenced to the center peaks of residual solvents (CHCl₃, δ 77.16; C₆H₆, 6128.06). Chemical shifts for silicon are reported in parts per million downfield from tetramethylsilane and are referenced to a tetramethylsilane internal standard. For ²⁹Si NMR, a DEPT pulse sequence was employed for the amplification of the signal at 20° angle. Chemical shifts for phosphorous and tin are reported downfield from 85% H₃PO₄ and tetramethylstannane external standards, respectively. Data are represented as follows: chemical shift, multiplicity (s=singlet, d=doublet, t=triplet, m=multiplet, br=broad), coupling constants in Hertz, and integration. High-resolution mass spectrometry (HIRMS) was recorded on either an Agilent 7200 GCMS-QTOF in methane chemical ionization mode, or a Waters XEVO G2XS QToF mass spectrometer equipped with a UPC2 SFC inlet, electrospray ionization (ESI) probe, atmospheric pressure chemical ionization (APCI) probe, and atmospheric solids analysis probe (ASAP+).

Reaction monitoring via ¹H NMR Spectroscopy for FIG. 3c, 3d
Experiment Shown in FIG. 3c—Isomerization with AlCl₃ (1.7 Equiv.)

An oven-dried 15 mL pressure tube was equipped with a stir bar and charged with 1 (0.11 g, 0.14 mmol, 1.0 equiv.), AlCl₃ (0.031 g, 0.24 mmol, 1.7 equiv.), and tetradecane (0.072 mL, 0.28 mmol, 2.0 equiv.) as internal standard. The mixture was further diluted with 0.46 mL benzene and stirred at room temperature. Reaction aliquots were taken at the indicated timepoints in FIG. 3c in the main text by dipping an oven-dried glass pipette tip into the heterogeneous reaction mixture stirring in the glovebox, rinsing the pipette tip with anhydrous benzene-d6, then filtering the solution with a 0.22 μm syringe filter into an NMR tube.

Percent yields at each timepoint were determined using the ‘Line Fitting’ function in MestReNova Version 14.1. The following peaks were used to determine concentration relative to tetradecane (δ 0.92, t, 6H): 1 (δ 0.63 ppm, 6H), 2 (δ 0.61, 36H; 0.35, 36H), 3 (δ 1.03, 3H; δ 0.59, 6H; δ 0.32, 9H), 6 (δ 0.65, 18H; δ 0.33, 27H). Concentration values were determined each individual peak, averaged to account for differences in relaxation time, then plotted using Graphpad Prism 9.1.

Experiment Shown in FIG. 3d—Isomerization with AlCl₃ (1.7 Equiv., SiMe₃Cl (1.0 equiv.)

An oven-dried 15 mL pressure tube was equipped with a stir bar and charged with 1 (0.20 g, 0.27 mmol, 1.0 equiv.), AlCl₃ (0.061 g, 0.46 mmol, 1.7 equiv.), trimethylsilyl chloride (1.0 M solution in benzene, 0.27 mL, 0.27 mmol, 1.0 equiv.), and cyclohexane (0.086 mL, 0.60 mmol, 2.3 equiv.) as internal standard. The mixture was further diluted with 0.67 mL benzene and stirred at room temperature. Reaction aliquots were taken at the indicated timepoints in FIG. 3d in the main text by dipping an oven-dried glass pipette tip into the heterogeneous reaction mixture stirring in the glovebox, rinsing the pipette tip with anhydrous benzene-d6, then filtering the solution with a 0.22 μm syringe filter into an NMR tube.

Percent yields at each timepoint were determined using the ‘Line Fitting’ function in MestReNova Version 14.1. The following peaks were used to determine concentration relative to cyclohexane (δ 1.41, 12H): 1 (δ 0.63 ppm, 6H), 2 (δ 0.61, 36H; 0.35, 36H), 3 (δ 1.03, 3H; δ 0.59, 6H; δ 0.32, 9H), 6 (δ 0.65, 18H; δ 0.33, 27H). Concentration values were determined from each individual peak, averaged to account for differences in relaxation time, then plotted using Graphpad Prism 9.1.

### Synthetic Procedures and Characterization of Compounds

### Examples

### 2 (SiAd) via Aluminum Chloride

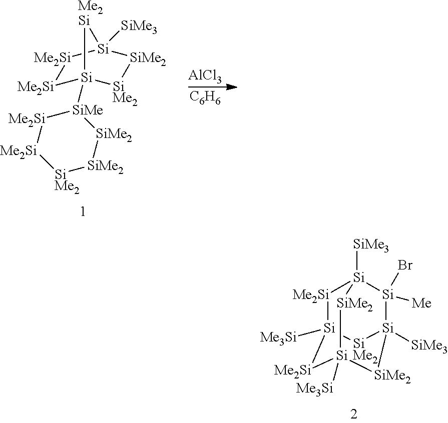

In a procedure adapted from Marschner and coworkers,¹ an oven-dried, 15 mL pressure tube equipped with a stir bar was brought into the glovebox and charged with 1 (1.0 g, 1.33 mmol, 1.0 equiv.), AlCl₃ (0.30 g, 2.25 mmol, 1.7 equiv.) and benzene (5 mL). The resulting cloudy mixture was stirred for 48 hours before the reaction was determined to be complete by ¹H NMR monitoring. The reaction mixture was removed from the glovebox and quenched with a 1 M hydrochloric acid solution (7 mL). The aqueous layer was extracted with hexanes (3×50 mL). The organic layers were combined, washed with brine, dried over magnesium sulfate, then concentrated in vacuo to yield a white crude solid. This material was purified via flash column chromatography in hexanes to yield pure SiAd 2 (0.39 g, 39% yield) as a white solid. ¹H NMR (400 MHz, C₆D₆) δ 0.61 (s, 36H), 0.35 (s, 36H). ¹³C NMR (101 MHz, C₆D₆) δ 5.03, 4.14. ²⁹Si-DEPT NMR (79 MHz, C₆D₆) δ −4.68, −25.88, −118.71.

Note: At room temperature, a reaction concentration of ≥0.26 M is key to observing reproducible isomerization outcomes under these conditions. We did not observe isomerization on these timescales and under these conditions at room temperature with 0.13 M solutions. The purity of AlCl₃ also impacts the isomerization: while anhydrous AlCl₃ purchased from Sigma-Aldrich (99.999% purity) enabled isomerization at room temperature on a two-day timescale, anhydrous AlCl₃ purchased from Strem (99.99% purity) typically required an extra day to isomerize. At room temperature, 0.85 equivalents of AlCl₃ did not lead to appreciable isomerization over a five-day period, though this quantity was sufficient for isomerization at higher temperatures (50° C.). Less time is required to achieve complete isomerization of 1 at higher temperatures: for example, the reaction is completed in 30 minutes at 80° C. in benzene with 1.7 equivalents of AlCl₃. However, we generally obtained lower isolated yields at higher temperatures.

2 (SiAd) Via trityl tetrakis(pentafluorophenyl)borate

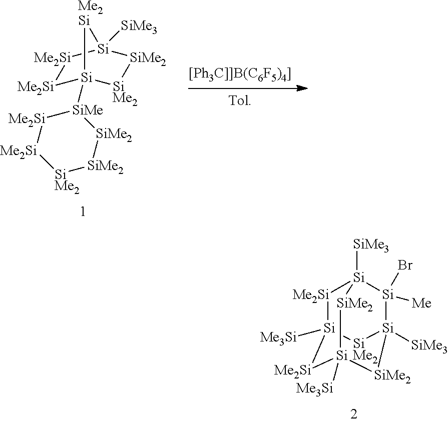

An oven-dried 50 mL pressure tube equipped with a stir bar was brought into the glovebox and charged with 1 (1.76 g, 2.33 mmol, 1.0 equiv.), trityl tetrakis(pentafluorophenyl)borate (0.22 g, 0.23 mmol, 0.10 equiv.) and toluene (8.5 mL). The red reaction mixture was stirred vigorously at room temperature for 48 hours before the reaction was deemed complete via ¹H NMR monitoring. The biphasic mixture was removed from the glovebox and subjected to a −78° C. dry ice/acetone bath to freeze the denser polar phase. The nonpolar phase was pipetted out, then subjected to an aqueous work up with a 1 M hydrochloric acid solution (10 mL). The organic layer was separated, and the aqueous layer was extracted with hexanes (3×50 mL). The organic layers were combined, washed with brine, dried over magnesium sulfate, then concentrated in vacuo to yield a white waxy crude solid. The material was dissolved in hexanes and purified via flash column chromatography in hexanes to yield SiAd 2 (1.20 g, 68% yield) as a white solid. The material may also be purified by recrystallization in hexanes. ¹H NMR (400 MHz, C₆D₆) δ 0.61 (s, 36H), 0.35 (s, 36H). ¹³C NMR (101 MHz, C₆D₆) δ 5.03, 4.14. ²⁹Si-DEPT NMR (79 MHz, C₆D₆) δ −4.68, −25.88, −118.71.

### 3 (2C-SiAd)

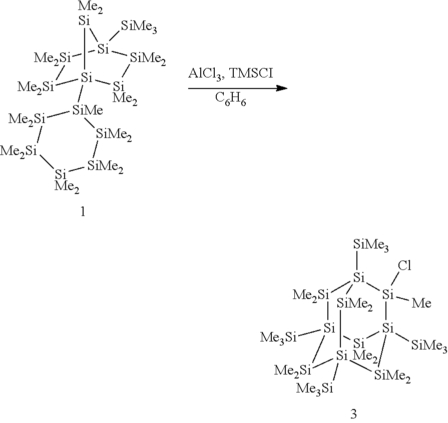

A 4 mL vial equipped with a stir bar was brought into a glovebox and charged with 1 (0.075 g, 0.10 mmol, 1.0 equiv.), AlCl₃ (0.023 g, 0.17 mmol, 1.7 equiv.), trimethylsilyl chloride (1.0 M solution in benzene, 0.10 mL, 0.10 mmol, 1.0 equiv.), and benzene (0.15 mL). The cloudy mixture was stirred for 48 hours before the reaction was determined to be complete by ¹H NMR monitoring. The vial was removed from the glovebox and quenched with a 1 M hydrochloric acid solution (2 mL). The aqueous layer was extracted with hexanes (3×10 mL) and the combined organic layers were brine-washed, dried over magnesium sulfate, then concentrated in vacuo to yield a white-yellow solid. The crude product was purified via flash column chromatography in hexanes to yield 3 as a white solid (0.016 g, 21% yield). ¹H NMR (600 MHz, C₆D₆) δ 1.03 (s, 3H), 0.81 (s, 6H), 0.59 (s, 6H), 0.58 (s, 6H), 0.57 (s, 6H), 0.51 (s, 6H), 0.42 (s, 18H), 0.35 (s, 9H), 0.32 (s, 9H). ¹³C NMR (151 MHz, CDCl₃) δ 10.06, 4.90, 4.84, 4.56, 3.79, 3.69, 3.62, 3.27, 1.18. ²⁹Si-DEPT NMR (79 MHz, CDCl₃) δ 31.64, −4.06, −4.52, −4.54, −25.37, −26.02, −27.63, −111.99, −118.96, −118.97. HRMS (TOF MS CI+) for [C₂₃H₆₉ClSi₁₄]: calculated=772.1858, found=772.1871 [M]⁺. Crystals suitable for single-crystal X-ray diffraction studies were grown by methanol vapor diffusion into a concentrated toluene solution.

4 (1-, 3-,5-, 7-(CH₂SMe)₄-SiAd)

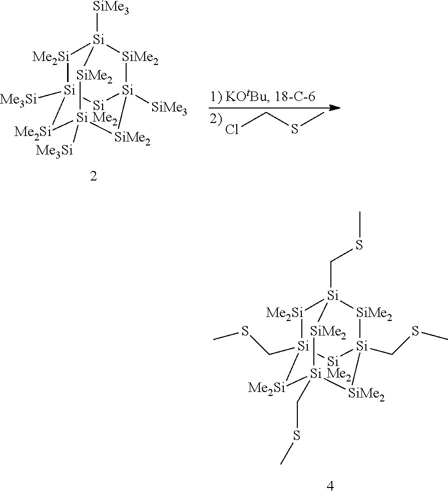

An oven-dried 10 mL Schlenk flask equipped with a stir bar was brought into a glovebox and charged with 2 (0.050 g, 0.066 mmol 1.0 equiv.), potassium tert-butoxide (0.030 g, 0.27 mmol, 4.0 equiv.), 18-crown-6 (0.070 g, 0.27 mmol, 4.0 equiv.) and toluene (3 mL). The resulting dark orange mixture was left to stir for 16 hours. Then, the flask was taken out of the glovebox and connected to a Schlenk manifold upon which chloromethyl methyl sulfide (22.2 μL, 0.27 mmol, 4.0 equiv.) was added and the reaction mixture turned colorless. The mixture was stirred for 3 hours before the reaction was quenched with a 1 M hydrochloric acid solution (5 mL). The aqueous layer was extracted with hexanes (3×10 mL) and the combined organic layers were brine-washed, dried over magnesium sulfate, then concentrated in vacuo to yield a colorless oil. The crude product was further purified by flash chromatography using a gradient from 100% hexanes to 40% dichloromethane in hexanes to yield 4 as a white waxy solid (0.017 g, 36% yield). ¹H NMR (400 MHz, CDCl₃) δ 2.26 (s, 8H), 2.19 (s, 12H), 0.48 (s, 36H). ¹³C NMR (101 MHz, CDCl₃) δ 22.19, 15.13, 0.08. ²⁹Si-DEPT NMR (119 MHz, CDCl₃) δ −30.99, −69.88. HRMS (TOF MS ASAP+) for [C₂₀H₅₇S₄Si₁₀]: calculated=705.1036, found=705.1039 [M+H]⁺ Crystals suitable for single-crystal X-ray diffraction studies were grown by methanol vapor diffusion into a concentrated toluene solution.

5 (1-Me, 3-SiᵢPr₃, 5-CH₂SMe, 7-Br—SiAd)

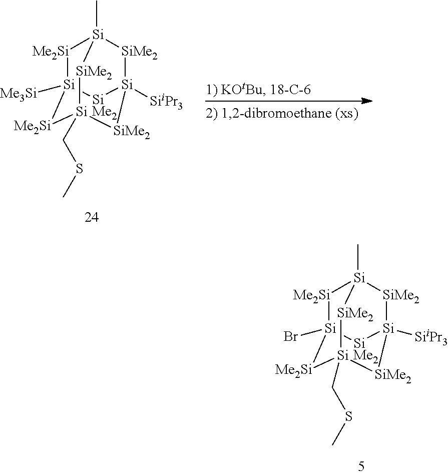

An oven-dried 10 mL Schlenk flask equipped with a stir bar was brought into a glovebox and charged with 24 (0.062 g, 0.081 mmol, 1.0 equiv.), potassium tert-butoxide (0.0091 g, 0.081 mmol, 1.0 equiv.), 18-crown-6 (0.021 g, 0.081 mmol, 1.0 equiv.) and toluene (2 mL). The resulting orange mixture was left to stir for 16 hours. Then, the flask was taken out of the glovebox and connected to a Schlenk manifold upon which excess 1,2-dibromoethane (0.14 mL, 1.61 mmol, 20 equiv.) was added the reaction mixture and the mixture turned colorless. The mixture was allowed to stir for 3 hours before being concentrated to dryness. The resulting salts were washed with dry pentane and the mixture was syringe filtered with a 0.22 m syringe filter. Upon evaporation of the pentane filtrate, the product was obtained as a white semisolid (0.060 g, 96% yield). ¹H NMR (400 MHz, C₆D₆) δ 2.28 (s, 2H), 1.91 (s, 3H), 1.37-1.36 (m, 3H, overlapping with grease), 1.20 (d, J=5.8 Hz, 18H), 0.76 (s, 3H), 0.67 (s, 3H), 0.66 (s, 3H), 0.65 (s, 3H), 0.61 (s, 3H), 0.60 (s 3H), 0.59 (s, 3H), 0.53 (s, 3H), 0.50 (s, 3H), 0.49 (s, 3H), 0.46 (s, 3H), 0.46 (s, 3H), 0.26 (s, 3H). ¹³C NMR (151 MHz, C₆D₆) δ 21.78, 20.29, 16.10, 15.39, 14.42, 2.92, 2.69, 1.93, 1.74, 1.45, 0.14, −0.10, −1.13, −1.17, −1.59, −1.94, −13.06. ²⁹Si-DEPT NMR (119 MHz, C₆D₆) δ 17.89, −9.69, −26.92, −27.07, −28.04, −29.19, −29.44, −31.52, −65.91, −70.32, −122.22. HRMS (TOF MS ASAP+) for [C₂₄H₆₆Si₁₁BrS]: calculated=773.1531, found=773.1540 [M+H]⁺ Crystals suitable for single-crystal X-ray diffraction studies were grown by methanol vapor diffusion into a concentrated toluene solution.

### 6 (1SiMe₂Cl—SiAd)

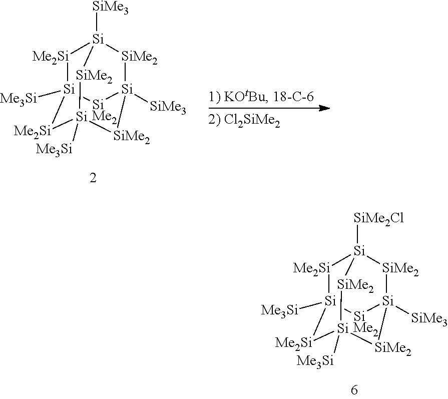

An oven-dried 10 mL Schlenk flask equipped with a stir bar was brought into a glovebox and charged with 2 (0.075 g, 0.10 mmol, 1.0 equiv.), potassium tert-butoxide (0.011 g, 0.10 mmol 1.0 equiv.), 18-crown-6 (0.026 g, 0.10 mmol 1.0 equiv.) and toluene (2 mL). The resulting orange mixture was left to stir for 16 hours. Then, the flask was taken out of the glovebox and connected to a Schlenk manifold upon which dichlorodimethylsilane (6.0 μL, 0.050 mmol, 1.0 equiv.) was added and the reaction mixture turned colorless. The mixture was allowed to stir for 3 hours before the reaction was quenched with a 1 M hydrochloric acid solution (5 mL). The aqueous layer was extracted with hexanes (3×10 mL) and the combined organic layers were brine-washed, dried over magnesium sulfate, then concentrated in vacuo to yield a white solid. The product was further purified by recrystallization in hexanes to yield 6 as a white solid (0.065 g, 84% yield). ¹H NMR (600 MHz, C₆D₆) δ 0.67 (s, 6H), 0.65 (s, 18H), 0.59 (s, 18H), 0.33 (s, 27H). ¹³C NMR (151 MHz, CDCl₃) δ 9.87, 4.87, 3.83, 3.79, 3.52. ²⁹Si-DEPT NMR (119 MHz, CDCl₃) δ 34.15, −4.69, −26.29, −26.82, −115.80, −118.47. HRMS (TOF MS ASAP+) for [C₂₂H₆₆ClSi₁₄]⁺: calculated=757.1623, found=757.1635 [M−CH]⁺.

### 9 (2Br—SiAd)

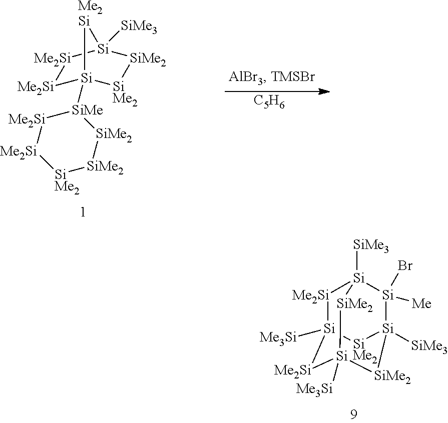

An oven-dried 4 mL vial equipped with a stir bar was brought into a glovebox and charged with 1 (0.11 g, 0.14 mmol, 1.0 equiv.), AlBr₃ (0.064 g, 0.24 mmol, 1.7 equiv.), trimethylsilyl bromide (18.5 μL, 0.14 mmol, 1.0 equiv.), benzene (0.45 mL, 5.0 mmol) and tetradecane as an internal standard (73 μL, 0.28 mmol, 2.0 equiv.). The opaque orange-red solution was stirred for 17 days. The vial was then taken out of the glovebox, quenched with acetone (1 mL) and subjected to an aqueous workup with a 1 M hydrochloric acid solution (2 mL). The aqueous layer was extracted with hexanes (3×5 mL) and the combined organic layers were brine-washed, dried over magnesium sulfate, then concentrated in vacuo to give a colorless crude solid. Purification with flash silica gel chromatography with hexanes yielded 7 as a colorless solid (6 mg, 6% yield). ¹H NMR (400 MHz, C₆D₆) δ 1.22 (s, 3H), 0.84 (s, 6H), 0.59 (s, 6H), 0.58 (s, 6H), 0.57 (s, 6H), 0.52 (s, 6H), 0.43 (s, 18H), 0.34 (s, 9H), 0.32 (s, 9H). ²⁹Si-DEPT NMR (79 MHz, C₆D₆) δ 21.12, −3.88, −4.84, −4.92, −25.67, −26.57, −27.24, −112.07, −118.96, −119.34. HRMS (TOF MS ASAP+) for [C₂₃H₆₉BrSi₁₄]: calculated=818.1337, found=818.1334 [M]⁺.

### 11 (1SiMe₂Ph-SiAd)

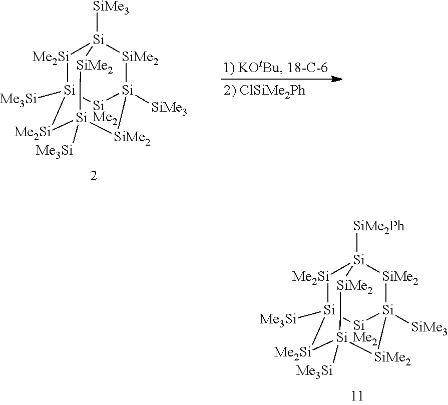

An oven-dried 10 mL Schlenk flask equipped with a stir bar was brought into a glovebox and charged with 2 (0.075 g, 0.10 mmol, 1.0 equiv.), potassium tert-butoxide (0.011 g, 0.10 mmol, 1.0 equiv.) and 18-crown-6 (0.026 g, 0.10 mmol, 1.0 equiv.). The solids were then dissolved in toluene(2 mL) and the resulting orange mixture was left to stir for 16 hours. The flask was taken out of the glovebox and connected to a Schlenk manifold upon which chlorodimethylphenylsilane (0.017 μL, 0.10 mmol, 1.0 equiv.) was added and the reaction mixture turned colorless. The mixture was allowed to stir for 3 hours before the reaction was quenched with a 1 M hydrochloric acid solution (5 mL). The aqueous layer was extracted with hexanes (3×10 mL) and the combined organic layers were brine-washed, dried over magnesium sulfate, then concentrated in vacuo to yield a white solid. The crude product was purified via flash column chromatography in hexanes to yield 11 as a white solid (0.025 g, 33% yield). ¹H NMR (400 MHz, C₆D₆) δ 7.58-7.55 (m, 2H), 7.25-7.21 (m, 3H), 0.61 (s, 6H), 0.59 (s, 9H), 0.58 (s, 9H), 0.51 (s, 18H), 0.33 (s, 27H). ¹³C NMR (151 MHz, CDCl₃) δ 142.06, 134.20, 128.62, 127.98, 4.91, 3.84, 3.79, 3.53, 2.89. ²⁹Si-DEPT NMR (119 MHz, CDCl₃) δ −4.92, −10.25, −25.83, −26.43, −118.36, −118.89. HRMS (TOF MS ASAP+) for [C₃₉H₇₈Si₁₄]: calculated=814.2560, found=814.2551 [M]⁺.

### 12 (1SiPh₃-SiAd)

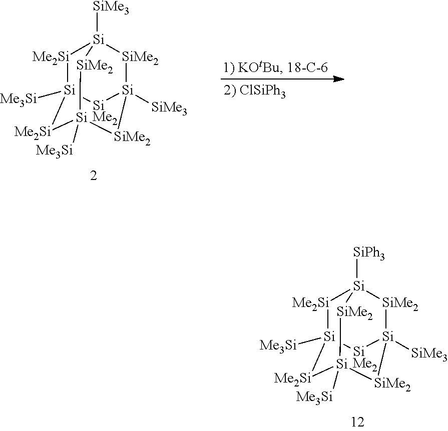

An oven-dried 10 mL Schlenk flask equipped with a stir bar was brought into a glovebox and charged with 2 (0.10 g, 0.13 mmol, 1.0 equiv.), potassium tert-butoxide (0.015 g, 0.13 mmol, 1.0 equiv.) and 18-crown-6 (0.035 g, 0.13 mmol 1.0 equiv.). The solids were then dissolved in toluene (2.0 mL) and capped with a septum. The resulting orange mixture was left to stir for 16 hours. The flask was taken out of the glovebox, connected to a Schlenk manifold, and subjected to positive pressure nitrogen. The septum was then removed, upon which chlorotriphenylsilane (0.039 g, 0.10 mmol, 1.0 equiv.) was added under a positive nitrogen flow, after which the reaction mixture turned colorless. The flask was recapped with a septum, and the mixture was allowed to stir for 3 more hours before the reaction was quenched with a 1 M hydrochloric acid solution (5 mL). The aqueous layer was extracted with hexanes (3×10 mL) and the combined organic layers were brine-washed, dried over magnesium sulfate, then concentrated in vacuo to yield a white solid. The crude product was further purified by washing with cold hexanes to yield 12 as a white solid (0.067 g, 54% yield). ¹H NMR (400 MHz, C₆D₆) δ 7.86-7.84 (m, 6H), 7.70-7.68 (m, 3H), 7.26-7.22 (m, 6H), 0.58 (s, 9H), 0.57 (s, 9H), 0.45 (s, 18H), 0.30 (s, 27H). ¹³C NMR (151 MHz, CDCl₃) δ 137.12, 136.68, 129.12, 127.93, 5.04, 4.42, 3.83, 3.79. ²⁹Si NMR (79 MHz, C₆D₆) δ −4.68, −11.04, −24.58, −26.61, −116.05, −117.12. HRMS (TOF MS ASAP+) for [C₃₉H₇₈Si₁₄]: calculated=939.2883, found=939.2834 [M]⁺.

### 13 (1Me-SiAd)

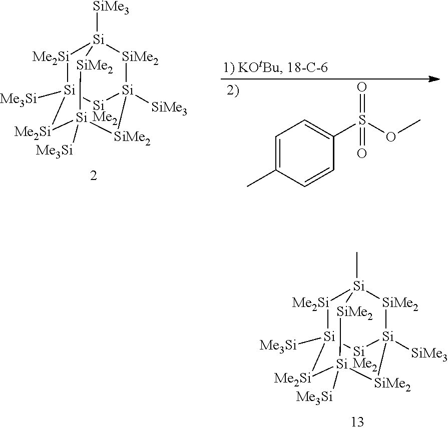

An oven-dried 10 mL Schlenk flask equipped with a stir bar was brought into a glovebox and charged with 2 (0.091 g, 0.12 mmol, 1.0 equiv.), potassium tert-butoxide (0.014 g, 0.12 mmol, 1.0 equiv.) and 18-crown-6 (0.032 g, 0.12 mmol, 1.0 equiv.). The solids were then dissolved in toluene(2 mL) and the resulting orange mixture was left to stir for 16 hours. Then, the flask was taken out of the glovebox, connected to a Schlenk manifold, and subjected to positive pressure nitrogen. The septum was then removed, upon which methyl-p-toluenesulfonate (0.023 g, 0.12 mmol, 1.0 equiv.) was added under positive nitrogen flow, after which the reaction mixture turned colorless. The mixture was allowed to stir for 3 more hours before the reaction was quenched with a 1 M hydrochloric acid solution (5 mL). The aqueous layer was extracted with hexanes (3×10 mL) and the combined organic layers were brine-washed, dried over magnesium sulfate, then concentrated in vacuo to yield a white solid. (0.082 g, 97% yield). ¹H NMR (600 MHz, C₆D₆) δ 0.60 (s, 9H), 0.59 (s, 9H), 0.50 (s, 18H), 0.34 (s, 27H), 0.28 (s, 3H). ¹³C NMR (151 MHz, C₆D₆) δ 4.82, 4.15, 3.97, 1.15, −13.99. ²⁹Si-DEPT NMR (119 MHz, C₆D₆) δ 4.66, −20.75, −24.97, −68.88, −112.34. HRMS (TOF MS ASAP+) for [C₂₂H₆₆Si₁₃]: calculated=694.2165, found=694.2162 [M]⁺.

### 14 (1GeMe₃-SiAd)

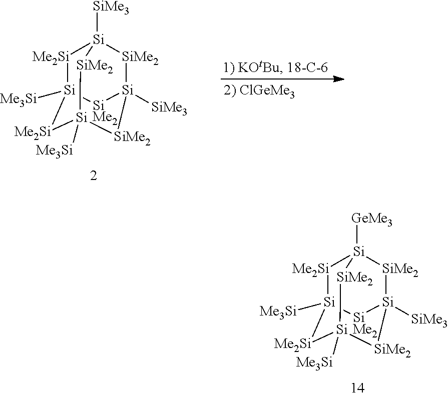

An oven-dried 10 mL Schlenk flask equipped with a stir bar was brought into a glovebox and charged with 2 (0.050 g, 0.066 mmol, 1.0 equiv.), potassium tert-butoxide (0.0074 g, 0.066 mmol, 1.0 equiv.) and 18-crown-6 (0.018 g, 0.066 mmol, 1.0 equiv.) and toluene (2 mL). The resulting orange mixture was left to stir for 16 hours. The flask was then taken out of the glovebox and connected to a Schlenk manifold upon which chlorotrimethylgermanium (8.2 μL, 0.066 mmol, 1.0 equiv.) was added. The mixture was allowed to stir for 3 more hours before the reaction was quenched with a 1 M hydrochloric acid solution (5 mL). The aqueous layer was extracted with hexanes (3×10 mL) and the combined organic layers were brine-washed, dried over magnesium sulfate, then concentrated in vacuo to yield a white solid. (0.050 g, 60% yield). ¹H NMR (600 MHz, C₆D₆) δ 0.61 (s, 9H), 0.60 (s, 18H), 0.57 (s, 9H) 0.50 (s, 9H), 0.35 (s, 27H). ¹³C NMR (151 MHz, C₆D₆) δ 4.97, 4.58, 4.13, 4.07, 4.01. ²⁹Si-DEPT NMR (119 MHz, C₆D₆) δ −4.67, −25.52, −25.88, −110.71, −118.18. HRMS (TOF MS ASAP+) for [C₂₄H₇₂GeSi₁₃]: calculated=798.1850, found=798.1837 [M]⁺.

### 15 (1SnMe₃-SiAd)

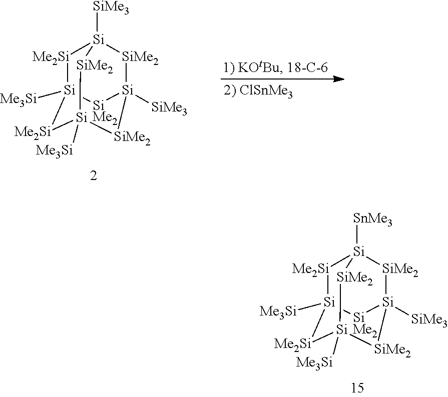

An oven-dried 10 mL Schlenk flask equipped with a stir bar was brought into a glovebox and charged with 2 (0.075 g, 0.10 mmol 1.0 equiv.), potassium tert-butoxide (0.011 g, 0.10 mmol, 1.0 equiv.), 18-crown-6 (0.026 g, 0.10 mmol, 1.0 equiv.) and toluene (2 mL). The resulting orange mixture was left to stir for 16 hours. Then, chlorotrimethyltin (0.0199 g, 0.100 mmol, 1.0 equiv.) was added under positive nitrogen flow, after which the reaction mixture turned colorless. The mixture was allowed to stir for 3 more hours before the flask was taken out of the glovebox and the reaction was quenched with a 1 M hydrochloric acid solution (5 mL). The aqueous layer was extracted with hexanes (3×10 mL) and the combined organic layers were brine-washed, dried over magnesium sulfate, then concentrated in vacuo to yield a white solid. (0.082 g, 98% yield). ¹H NMR (400 MHz, C₆D₆) δ 0.60 (s, 9H), 0.59 (s, 9H), 0.57 (s, 18H), 0.42 (s, 9H), 0.34 (s, 27H). ¹³CNMR (151 MHz, C₆D₆) δ 4.90, 4.27, 4.16, 4.08, −5.88. ²⁹Si-DEPT NMR (119 MHz, C₆D₆) δ −4.62, −24.54, −25.67, −117.39, −118.26. ¹¹⁹Sn NMR (149 MHz, C₆D₆) δ −64.36. HRMS (TOF MS ASAP+) for [C₂₄H₇₂Si₁₃Sn]: calculated=844.1652, found=844.1653 [M].

16 (1P(NEt₂)₂-SiAd)

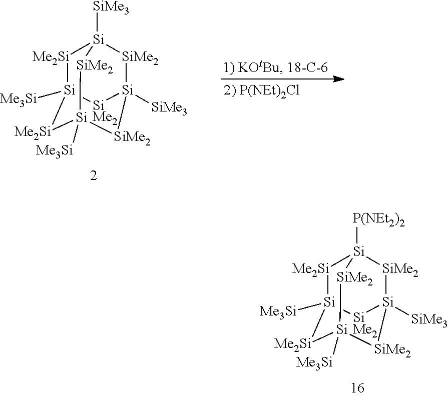

An oven-dried 10 mL Schlenk flask equipped with a stir bar was brought into a glovebox and charged with 2 (0.045 g, 0.060 mmol, 1.0 equiv.), potassium tert-butoxide (0.0067 g, 0.060 mmol, 1.0 equiv.), 18-crown-6 (0.016 g, 0.060 mmol, 1.0 equiv.) and toluene (2 mL). The resulting orange mixture was left to stir for 16 hours. Then, bis(diethylamino)chlorophosphine (12.55 μL, 0.0597 mmol, 1.0 equiv.) was added the reaction mixture and the mixture turned colorless. The mixture was allowed to stir for about 3 hours before being concentrated to dryness. The resulting solids were washed with dry pentane and the mixture was syringe filtered with a 0.22 μm syringe filter. Upon evaporation of the pentane filtrate, the crude product was obtained as a white waxy solid. The crude material was triturated with diethyl ether to obtain 16 as a white solid (0.032 g, 63% yield). ¹H NMR (400 MHz, C₆D₆) δ 3.27-3.10 (m, 8H), 1.11 (t, J=7.1 Hz, 12H) 0.72 (s, 18H), 0.65 (s, 9H), 0.63 (s, 9H), 0.38 (s, 27H). ¹³C NMR (151 MHz, C₆D₆) δ 15.14, 5.09, 4.09, 4.01, 3.58, 0.22. ²⁹Si NMR (119 MHz, C₆D₆) δ −4.70, −26.26 (d, ²J_{SiP}=17 Hz), −26.26, −87.69 (d, ¹J_{SiP}=99 Hz) −115.51 (d, ³J_{SiP}=5.8 Hz). ³¹P NMR (243 MHz, C₆D₆) δ 111.59. HRMS could not be obtained due to the ambient sensitivity of the product.

### 17 (1CH₂SMe-SiAd)

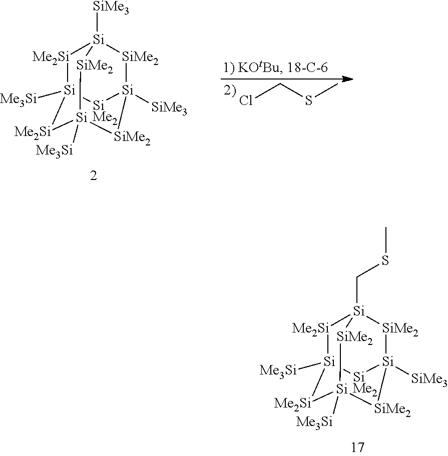

An oven-dried 10 mL Schlenk flask equipped with a stir bar was brought into a glovebox and charged with 2 (0.075 g, 0.10 mmol, 1.0 equiv.), potassium tert-butoxide (0.011 g, 0.10 mmol, 1.0 equiv.), 18-crown-6 (0.026 g, 0.10 mmol, 1.0 equiv.) and toluene (2 mL). The resulting orange mixture was left to stir for 16 hours. The flask was taken out of the glovebox and connected to a Schlenk manifold upon which chloromethyl methyl sulfide (8.5 μL, 0.10 mmol, 1.0 equiv.) was added and the reaction mixture turned colorless. The mixture was allowed to stir for 3 hours before the reaction was quenched with a 1 M hydrochloric acid solution (5 mL). The aqueous layer was extracted with hexanes (3×10 mL) and the combined organic layers were brine-washed, dried over magnesium sulfate, then concentrated in vacuo to yield a white solid. The crude product was further purified by flash chromatography using a gradient from 100% hexanes to 35% dichloromethane in hexanes to yield 17 as a white solid (0.024 g, 35% yield). ¹H NMR (400 MHz, CDCl₃) δ 2.26 (s, 2H), 2.19 (s, 3H), 0.48 (s, 18H), 0.47 (s, 9H), 0.46 (s, 9H), 0.27 (s, 27H). ¹³C NMR (151 MHz, C₆D₆) δ 21.95, 15.80, 4.85, 4.11, 3.89, 2.27. ²⁹Si-DEPT NMR (119 MHz, CDCl₃) δ −4.75, −25.99, −29.18, −70.63, −116.73. HRMS (TOF MS ASAP+) for [C₂₂H₆₅SSi₁₃]: calculated=725.1807, found=725.1813 [M−CH₃]⁺.

### 18 (1Br—SiAd)

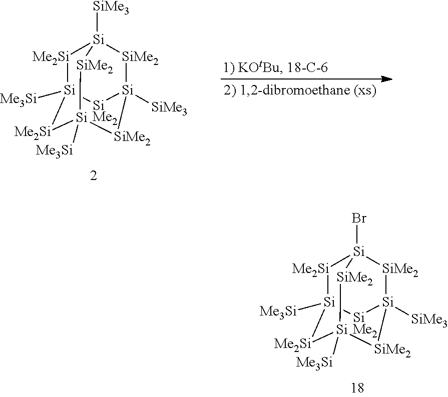

An oven-dried 10 mL Schlenk flask equipped with a stir bar was brought into a glovebox and charged with 2 (0.075 g, 0.10 mmol, 1.0 equiv.), potassium tert-butoxide (0.011 g, 0.10 mmol, 1.0 equiv.), 18-crown-6 (0.026 g, 0.10 mmol, 1.0 equiv.) and toluene (2 mL). The resulting yellow solution was left to stir for 16 hours before excess 1,2 dibromoethane (0.17 mL, 2.0 mmol, 20 equiv.) was syringed in upon which, the solution turned colorless. The mixture was allowed to stir for 3 more hours before being concentrated to dryness. The resulting salts were washed with dry pentane and the mixture was syringe filtered with a 0.22 μm syringe filter. Upon evaporation of the pentane solution, the product was obtained as a white waxy solid (0.063 g, 83% yield). ¹H NMR (400 MHz, C₆D₆) δ 0.61 (s, 18H), 0.54 (s, 9H), 0.54 (s, 9H), 0.28 (s, 27H). ¹³C NMR (151 MHz, C₆D₆) δ 4.51, 4.04, 3.62, 0.62. ²⁹Si-DEPT NMR (79 MHz, C₆D₆) δ −4.39, −12.70, −25.51, −28.58, −113.02. HRMS (TOF MS ASAP+) for [C₂₁H₆₃Si₁₃Br]: calculated=760.1097, found=760.1100 [M]⁺.

### 19 (1H—SiAd)

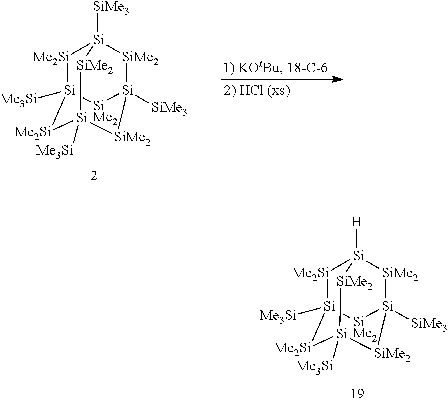

An oven-dried 10 mL Schlenk flask equipped with a stir bar was brought into a glovebox and charged with 2 (0.075 g, 0.10 mmol, 1.0 equiv.), potassium tert-butoxide (0.011 g, 0.10 mmol, 1.0 equiv.), 18-crown-6 (0.026 g, 0.10 mmol, 1.0 equiv.) and toluene (2 mL). The resulting orange mixture was left to stir for 16 hours. Then, the flask was taken out of the glovebox and connected to a Schlenk manifold upon which excess amounts of a 1 M hydrochloric acid solution (5 mL) was added and the reaction mixture turned colorless. The mixture was allowed to stir for 3 more hours before the aqueous layer was extracted with hexanes (3×10 mL) and the combined organic layers were brine-washed, dried over magnesium sulfate, then concentrated in vacuo to yield a white solid. (0.048 g, 70% yield). ¹H NMR (600 MHz, C₆D₆) δ 3.50 (s, 1H), 0.68 (s, 9H), 0.55 (s, 9H), 0.54 (s, 18H), 0.31 (s, 27H). ¹³C NMR (101 MHz, C₆D₆) δ 4.78, 4.13, 3.96, 3.32. ²⁹Si-DEPT NMR (79 MHz, C₆D₆) δ −4.52, −25.36, −29.20, −99.67, −118.21. HRMS (TOF MS CI+) for [C₂₁H₆₄Si₁₃]: calculated=680.2009, found=680.2028 [M]⁺.

20 (1-,3-(CH₂SMe)₂-SiAd)

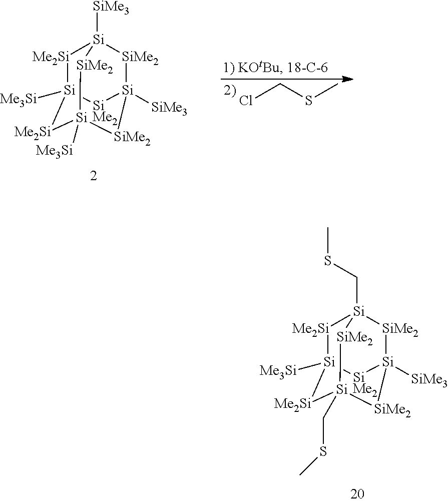

An oven-dried 10 mL Schlenk flask equipped with a stir bar was brought into a glovebox and charged with 2 (0.075 g, 0.10 mmol, 1.0 equiv.), potassium tert-butoxide (0.022 g, 0.20 mmol, 2.0 equiv.), an 18-crown-6 (0.053 g, 0.20 mmol, 2.0 equiv.). The resulting orange mixture was left to stir for 16 hours. Then, the flask was taken out of the glovebox and connected to a Schlenk manifold upon which chloro methyl methyl sulfide (16.8 μL, 0.20 mmol, 2.0 equiv.) was added and the reaction mixture turned colorless. The mixture was allowed to stir for 3 hours before the reaction was quenched with a 1 M hydrochloric acid solution (5 mL). The aqueous layer was extracted with hexanes (3×10 mL) and the combined organic layers were brine-washed, dried over magnesium sulfate, then concentrated in vacuo to yield a white solid. The crude product was further purified by flash chromatography using a gradient from 100% hexanes to 35% dichloromethane in hexanes to yield 20 as a white solid (0.010 g, 14% yield). ¹H NMR (400 MHz, CDCl₃) δ 2.26 (s, 4H), 2.19 (s, 6H), 0.50 (s, 6H), 0.48 (s, 12H), 0.47 (s, 12H), 0.46 (s, 6H), 0.27 (s, 18H). ¹³C NMR (151 MHz, CDCl₃) δ 22.23, 15.75, 4.62, 3.58, 1.94, 1.65, 0.30. ²⁹Si NMR (119 MHz, CDCl₃) δ −4.39, −25.84, −28.92, −30.84, −67.96, −118.09. HRMS (TOF MS ASAP+) for [C₂₂H₆₅S2Si₁₂]: calculated=729.1759, found=729.1728 [M+H]⁺.

21 (1-,3-,5-(CH₂SMe)₃-SiAd)

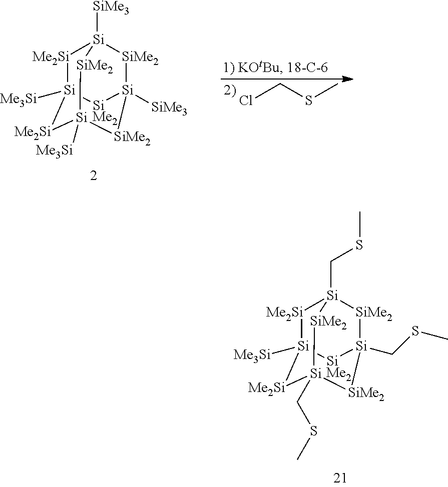

An oven-dried 10 mL Schlenk flask equipped with a stir bar was brought into a glovebox and charged with 2 (0.075 g, 0.10 mmol, 1.0 equiv.), potassium tert-butoxide (0.034 g, 0.30 mmol, 3.0 equiv.), 18-crown-6 (0.079 g, 0.30 mmol, 3.0 equiv.) and toluene (2 mL). The resulting orange mixture was left to stir for 16 hours. Then, the flask was taken out of the glovebox, and connected to a Schlenk manifold upon which chloro methyl methyl sulfide (25.1 μL, 0.300 mmol, 3.0 equiv.) was added and the reaction mixture turned colorless. The mixture was allowed to stir for 3 hours before the reaction was quenched with a 1 M hydrochloric acid solution (5 mL). The aqueous layer was extracted with hexanes (3×10 mL) and the combined organic layers were brine-washed, dried over magnesium sulfate, then concentrated in vacuo to yield a white solid. The crude product was further purified by flash chromatography using a gradient from 100% hexanes to 35% dichloromethane in hexanes to yield 21 as a white solid (0.020 g, 28% yield). ¹H NMR (400 MHz, CDCl₃) δ 2.25 (s, 6H), 2.19 (s, 9H), 0.50 (s, 9H), 0.48 (s, 9H), 0.46 (s, 18H), 0.27 (s, 9H). ¹³C NMR (101 MHz, CDCl₃) δ 22.20, 15.59, 4.55, 1.66, 0.37, 0.07. ²⁹Si-DEPT NMR (119 MHz, CDCl₃) δ −3.89, −28.83, −31.08, −67.90, −123.10. HRMS (TOF MS ASAP+) for [C₂₁H₆₁S3Si₁₁]: calculated=717.1397, found=717.1365 [M+H]⁺.

23 (1Me-3SiⁱPr₃—SiAd)

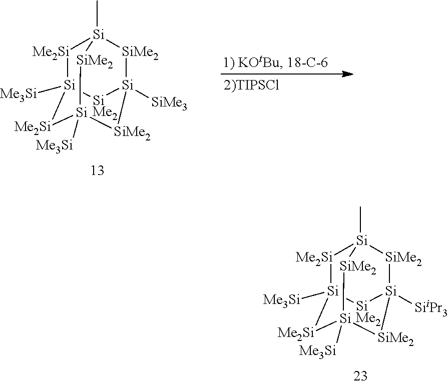

An oven-dried 10 mL Schlenk flask equipped with a stir bar was brought into a glovebox and charged with 13 (0.17 g, 0.25 mmol, 1.0 equiv.), potassium tert-butoxide (0.028 g, 0.25 mmol, 1.0 equiv.), 18-crown-6 (0.065 g, 0.25 mmol, 1.0 equiv.) and toluene (2 mL). The resulting orange mixture was left to stir for 16 hours. Then, the flask was taken out of the glovebox, and connected to a Schlenk manifold upon which chlorotriisopropylsilane (22.0 μL, 0.25 mmol, 1.0 equiv.) was added the reaction mixture that turned colorless over a 3-hour time period. The reaction was then quenched with a 1 M hydrochloric acid solution (5 mL). The aqueous layer was extracted with hexanes (3×10 mL) and the combined organic layers were brine-washed, dried over magnesium sulfate, then concentrated in vacuo to yield a white solid. The crude product was further purified by recrystallization in ethanol to yield 23 as a white solid (0.090 g, 44% yield). ¹H NMR (400 MHz, C₆D₆) δ 1.36-1.32 (m, 3H, overlapping with grease), 1.28-1.26 (d, J=8, 18H), 0.63 (s, 6H), 0.62 (s, 6H), 0.61 (s, 3H), 0.60 (s, 3H), 0.54 (s, 6H), 0.51 (s, 12H), 0.37 (s, 18H), 0.34 (s, 3H). ¹³C NMR (151 MHz, C₆D₆) δ 20.50, 15.35, 5.50, 5.30, 5.04, 4.08, 3.91, 2.16, 1.18, 1.05, −13.68. ²⁹Si-DEPT NMR (119 MHz, C₆D₆) δ 16.47, −4.72, −24.02, −26.33, −29.10, −30.34, −72.58, −113.83, −114.79. HRMS (TOF MS ASAP+) for [C₂₇H₇₅Si₁₃]: calculated=763.2869, found=763.2884 [M−CH₃]⁺.

24 (1Me-3SiⁱPr₃-5SMe-SiAd)

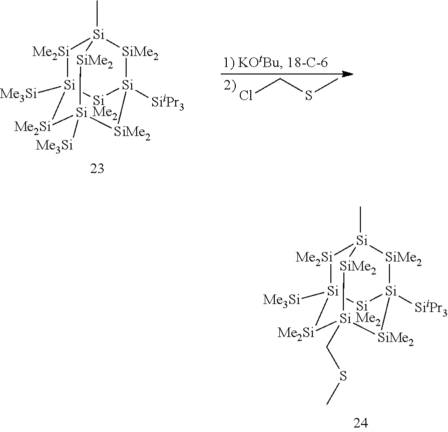

An oven-dried 10 mL Schlenk flask equipped with a stir bar was brought into a glovebox and charged with 23 (0.090 g, 0.12 mmol, 1.0 equiv.), potassium tert-butoxide (0.013 g, 0.12 mmol, 1.0 equiv.) and 18-crown-6 (0.030 g, 0.12 mmol, 1.0 equiv.). The resulting orange mixture was left to stir for 16 hours. Then, the flask was taken out of the glovebox, and connected to a Schlenk manifold upon which chloro methyl methyl sulfide (9.6 μL, 0.12 mmol, 1.0 equiv.) was added and the reaction mixture turned colorless. The mixture was allowed to stir for 3 hours before the reaction was quenched with a 1 M hydrochloric acid solution (5 mL). The aqueous layer was extracted with hexanes (3×10 mL) and the combined organic layers were brine-washed, dried over magnesium sulfate, then concentrated in vacuo to yield a waxy, white solid. (0.063 g, 71% yield).¹H NMR (600 MHz, C₆D₆) δ 2.34 (s, 2H), 1.93 (s, 3H), 1.37-1.35 (m, 3H, overlapping with grease), 1.26-1.25 (d, J=6 Hz, 18H), 0.73 (s, 3H), 0.68 (s, 3H), 0.65 (s, 3H), 0.65 (s, 3H), 0.65 (s, 3H), 0.60 (s, 3H), 0.59 (s, 3H), 0.59 (s, 3H), 0.53 (s, 3H), 0.52 (s, 3H), 0.50 (s, 3H), 0.49 (s, 3H), 0.35 (s, 9H), 0.29 (s, 3H). ¹³C NMR (151 MHz, C₆D₆) δ 21.93, 20.46, 16.31, 15.34, 14.40, 5.33, 4.95, 3.20, 2.88, 2.73, 2.18, 1.98, 1.72, 1.19, 0.90, 0.18, −0.55, −13.37. ²⁹Si-DEPT NMR (79 MHz, C₆D₆) δ 16.68, −4.19, −23.65, −27.47, −28.58, −28.80, −29.91, −31.13, −66.70, −70.01, −115.49, −116.45. HRMS (TOF MS ASAP+) for [C₂₇H₇₅Si₁₂S]: calculated=767.2820 found=767.2878 [M+H]⁺.

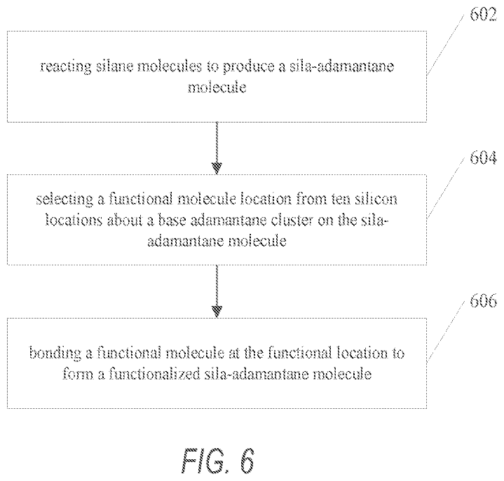

FIG. 6 shows an example method of formation of a functionalized sila-adamantane material. In operation 602, silane molecules are reacted to produce a sila-adamantane molecule. In operation 604, a functional molecule location is selected from ten silicon locations about a base adamantane cluster on the sila-adamantane molecule. In operation 606, a functional molecule is bonded at the functional location to form a functionalized sila-adamantane molecule.

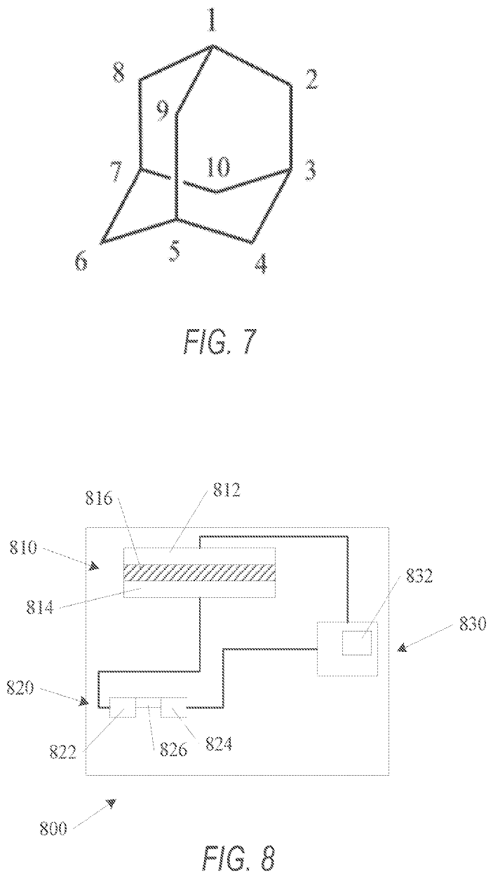

FIG. 7 shows a diagram of an example sila-adamantane molecule with silicon locations of a base adamantane cluster labelled one through ten.

FIG. 8 shows a block diagram of an example electronic device 800 according to selected examples. The electronic device 800 includes a battery 810, a transistor 820 and a light emitter 830. The battery 810 includes a first electrode 812 and a second electrode 814 separated by an electrolyte 816. In one example, one or more electrodes 812, 814 include a functionalized sila-adamantane material as described. The transistor 820 includes a first source/drain region 822, a second source/drain region 824, and a channel region 826 located between the source/drain regions 822 and 824. In one example, one or more source/drain regions 822, 824 include a functionalized sila-adamantane material as described. The light emitter 830 includes a doped material 832 that is tailored to have a band gap that emits a desired frequency of light. In one example, the light includes a blue light in a range of approximately 350-450 nm of wavelength. In one example, the doped material 832 include a functionalized sila-adamantane material as described.

To better illustrate the devices and methods disclosed herein, a non-limiting list of embodiments is provided here:

Example 1 includes a sila-adamantane material. The sila-adamantane material includes a base adamantane cluster of silicon atoms, ten silicon locations about the base adamantane cluster, a functional molecule attached to one or more of the ten silicon locations, and methyl molecules at non-functional silicon locations.

Example 2 includes the sila-adamantane material of example 1, wherein the functional molecule includes a halide.

Example 3 includes the sila-adamantane material of any one of examples 1-2, wherein the functional molecule is SiMe₂Cl.

Example 4 includes the sila-adamantane material of any one of examples 1-3, wherein the functional molecule is attached at the second of ten silicon locations.

Example 5 includes the sila-adamantane material of any one of examples 1-4, wherein four functional molecules are attached at four selected locations of the ten silicon locations.

Example 6 includes the sila-adamantane material of any one of examples 1-5, wherein the four functional molecules are attached at the first, third, fifth and seventh of ten silicon locations.

Example 7 includes the sila-adamantane material of any one of examples 1-6, wherein the four functional molecules are the same.

Example 8 includes the sila-adamantane material of any one of examples 1-7, wherein the four functional molecules are each different from one another.

Example 9 includes an electronic device. The electronic device includes an electronic component including a plurality of assembled sila-adamantane molecules, each sila-adamantane molecule including, a base adamantane cluster of silicon atoms, ten silicon locations about the base adamantane cluster, a functional molecule attached to one or more of the ten silicon locations, and methyl molecules at non-functional silicon locations.

Example 10 includes the electronic device of example 9, wherein the electronic component is part of a battery electrode.

Example 11 includes the electronic device of any one of examples 9-10, wherein the electronic component is part of a light emitting device.

Example 12 includes the electronic device of any one of examples 9-11, wherein the electronic component is part of circuitry in a computing device.

Example 13 includes a method. The method includes reacting silane molecules to produce a sila-adamantane molecule, selecting a functional molecule location from ten silicon locations about a base adamantane cluster on the sila-adamantane molecule, and bonding a functional molecule at the functional location to form a functionalized sila-adamantane molecule.

Example 14 includes the method of example 13, wherein bonding a functional molecule at the functional location includes bonding at a second location of the ten silicon locations.

Example 15 includes the method of any one of examples 13-14, wherein bonding a functional molecule at the functional location includes bonding four functional molecules at four locations of the ten silicon locations.

Example 16 includes the method of any one of examples 13-15, wherein bonding four functional molecules at four locations of the ten silicon locations includes bonding at a first, third, fifth and seventh of the ten silicon locations.

Example 17 includes the method of any one of examples 13-16, wherein bonding four functional molecules includes bonding four of the same molecule.

Example 18 includes the method of any one of examples 13-17, wherein bonding four functional molecules includes bonding four different molecules.

Example 19 includes the method of any one of examples 13-18, wherein bonding four functional molecules includes sequential functional molecule attachment.

Example 20 includes the method of any one of examples 13-19, wherein the method is performed as a single pot reaction.

Example 21 includes the method of any one of examples 13-20, further including utilizing the functionalized sila-adamantane molecule as a ligand in a catalytic reaction.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### Site-Selective Functionalization of Sila-Adamantane

Timothy C. Siu,¹ M. Imex Aguirre Cardenas,¹ Jacob Seo,¹ Kirllos Boctor,¹ Miku G. Shimono,¹ Isabelle T. Tran,¹ Veronica Carta,¹ Timothy A. Su^{1,2*}

¹Department of Chemistry, University of California, Riverside, California 92521 ²Materials Science and Engineering Program, University of California, Riverside, California 92521

### Supporting Information

Table of Contents

| | |
|---|---|
| I. Supplemental Figures from Main Text | S-2 |
| II. Synthetic Procedures and Characterization of Compounds | S-4 |
| 1. General Synthesis and Characterization Information | S-4 |
| 2. Reaction monitoring via ¹H NMR spectroscopy for | S-4 |
| FIG. 3c, 3d | |
| 3. Synthetic Procedures and Characterization of Compounds | S-5 |
| 4. NMR spectra | S-18 |
| III. Computational Chemistry Details | S-62 |
| IV. Crystallography Data | S-76 |
| V. Supplementary References | S-83 |

I. Supplemental Figures from Main Text

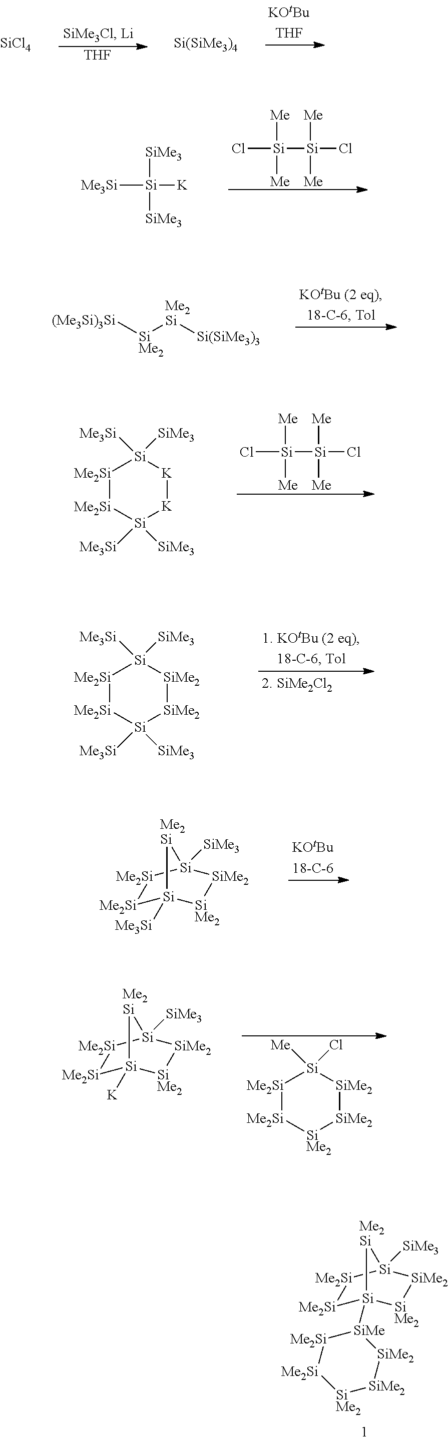

Figure S1. Synthetic scheme to access 1 adapted from Supplementary Refs. 1-3.

Figure S2. Overlay of ¹H NMR spectra comparing reaction mixture at 48-hour timepoint in isomerization reaction of 1 with AlCl₃ (1.7 equiv.) against isolated 3 and 6. The reaction mixture NMR spectrum (top) is the same as the one shown in FIG. 2a of the main text, but with peaks shown at higher intensity.

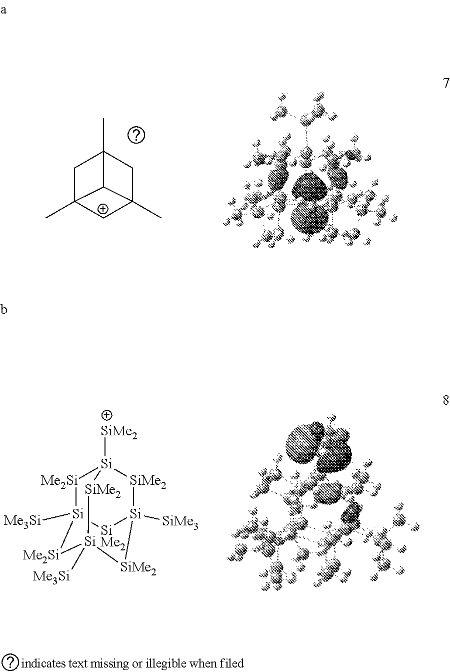

Figure S3. LUMO isosurfaces (isovalue=0.04) of (a) 2-cation 7 and (b) exo-cation 8, with geometries optimized at the M06-2X/6−311+(d,p) level without symmetry constraints. Bonds highlighted in red indicate bonds that interact with silylium 3p orbital in the LUMO.

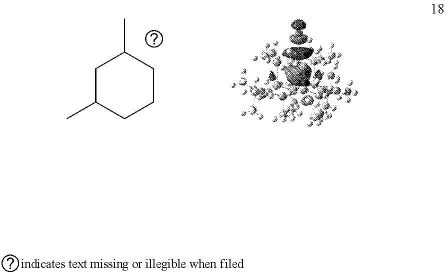

Figure S4. LUMO isosurface (isovalue=0.04) of 1Br—SiAd 18 with geometry optimized at the M06-2X/6-311+(d,p) level without symmetry constraints. Orbital density is located primarily in the cluster interior.

### II. Computational Chemistry Details

### General

Density functional theory calculations were carried out with Gaussian 16, revision C01.⁴ Molecular geometry optimizations were performed using the M06-2X functional and 6-311+G(d,p) basis set. This functional was selected because its geometry optimizations of 2 produced bond lengths and angles that were close to the published crystal structure of 2, compared against B3LYP-D3.¹ The M06-2X functional implicitly accounts for dispersion effects and was used previously in oligosilane thermochemical calculations.⁵⁻⁷ Every stationary point was identified as a minimum by a subsequent frequency calculation, with no imaginary frequencies observed. These thermochemical values are given below in Table S1.

TABLE S1
Computed thermochemical values at the M06-2X/6-311G + (d, p) level of theory,
including number of imaginary frequencies (NImag), zero−point energy correction (ZPE), self-
consistent field energy (E(SCF)), Gibbs free energy at 298.15 K (G²⁹⁸), Enthalpy (H). Relative
Gibbs free energy (ΔG) and relative enthalpy (ΔH) are calculated relative to the higher energy
isomer between 1 and 2 as well as between 7 and 8.

| | | | ZPE | E(SCF) | G²⁹⁸ | H²⁹⁸ | ΔG²⁹⁸ | ΔH²⁹⁸ |
|---|---|---|---|---|---|---|---|---|
| Entry | Formula | NImag | hartree | hartree | hartree | hartree | kcal mol⁻¹ | kcal mol⁻¹ |
| 1 | Si₁₄C₂₄H₇₂ | 0 | 0.9111 | −5010.8004 | −5009.9987 | −5009.8139 | 0.0 | 0.0 |
| 2 | Si₁₄C₂₄H₇₂ | 0 | 0.9133 | −5010.8438 | −5010.0333 | −5009.8569 | −21.7 | −27.0 |
| 7 | Si₁₄C₂₃H₆₉ | 0 | 0.8754 | −4970.6891 | −4969.9210 | −4969.7409 | −10.2 | −5.3 |
| 8 | Si₁₄C₂₃H₆₉ | 0 | 0.8772 | −4970.6811 | −4969.9047 | −4969.7325 | 0.0 | 0.0 |

The optimized geometries are provided below in xyz coordinates and ordered according to compound number.

### Molecule 1

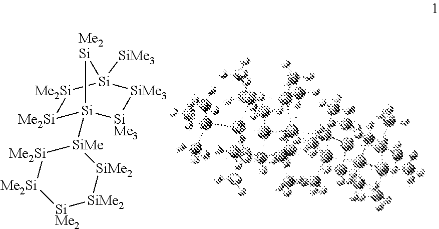

| | | | |
|---|---|---|---|
| Si | 1.71860 | −1.86210 | −1.72230 |
| Si | −4.01700 | −1.50020 | −1.31600 |
| Si | −4.09270 | 0.38020 | 0.09420 |
| C | −4.79950 | −3.04780 | −0.54810 |
| C | −4.91490 | −1.13850 | −2.94900 |
| Si | −2.09320 | 1.47890 | −0.51030 |
| Si | −0.65540 | −0.37850 | −0.22640 |
| C | −1.71140 | 2.90400 | 0.68240 |
| C | −2.17230 | 2.15740 | −2.28070 |
| C | −1.35350 | −1.38910 | −3.52480 |
| C | −1.25590 | −3.68800 | −1.51660 |
| Si | −3.51120 | −0.33560 | 2.25000 |
| Si | −1.24070 | −0.95570 | 1.98770 |
| C | −4.55030 | −1.77040 | 2.92360 |
| C | −3.66870 | 1.08300 | 3.50220 |
| C | −1.06600 | −2.81710 | 2.31780 |
| C | −0.21480 | 0.03420 | 3.24330 |
| Si | −6.07440 | 1.59780 | −0.13280 |
| C | −6.12850 | 2.40820 | −1.83530 |
| C | −6.19180 | 2.94020 | 1.18690 |
| C | −7.54140 | 0.42360 | 0.04580 |
| Si | 1.65120 | −0.14510 | −0.65080 |
| Si | 2.42870 | 2.00850 | −0.14970 |
| Si | 2.90060 | −1.82940 | 0.40850 |
| C | 1.91740 | −0.35820 | −2.53130 |
| Si | 5.17390 | −1.62580 | −0.13990 |
| C | 2.27100 | −3.52060 | −0.17560 |
| C | 2.78120 | −1.77850 | 2.30080 |
| Si | 5.99620 | 0.47850 | 0.48710 |
| C | 5.45650 | −1.90080 | −1.99520 |
| C | 6.13730 | −2.96650 | 0.80040 |
| Si | 4.74950 | 2.21750 | −0.46950 |
| C | 7.79920 | 0.63100 | −0.08920 |
| C | 5.95920 | 0.65280 | 2.37610 |
| C | 5.13110 | 2.30300 | −2.32690 |
| C | 5.29500 | 3.85930 | 0.31620 |
| C | 1.99680 | 2.51610 | 1.62270 |
| C | 1.61230 | 3.20210 | −1.38110 |
| H | −4.16290 | −3.46480 | 0.23570 |
| H | −4.92620 | −3.81810 | −1.31450 |
| H | −5.77910 | −2.83430 | −0.11240 |
| H | −4.47630 | −0.27970 | −3.46360 |
| H | −5.97340 | −0.92380 | −2.77540 |
| H | −4.85300 | −1.99950 | −3.62080 |
| H | −1.55410 | 2.52980 | 1.69700 |
| H | −2.54770 | 3.60870 | 0.71040 |
| H | −0.81530 | 3.45620 | 0.38960 |
| H | −2.73900 | 1.48750 | −2.93180 |
| H | −1.17750 | 2.29030 | −2.71370 |
| H | −2.67540 | 3.12860 | −2.28640 |
| H | −1.44150 | −0.31300 | −3.69030 |
| H | −2.06000 | −1.89090 | −4.19260 |
| H | −0.34450 | −1.69140 | −3.81320 |
| H | −1.36630 | −4.02870 | −0.48480 |
| H | −0.21890 | −3.85710 | −1.81800 |
| H | −1.89540 | −4.31120 | −2.14860 |
| H | −4.44880 | −2.67630 | 2.32490 |
| H | −5.60960 | −1.50030 | 2.94800 |
| H | −4.24040 | −2.00480 | 3.94630 |
| H | −3.27520 | 2.02540 | 3.11600 |
| H | −3.13530 | 0.84350 | 4.42670 |
| H | −4.72080 | 1.24090 | 3.75490 |
| H | −1.82520 | −3.37090 | 1.75860 |
| H | −1.21810 | −3.02940 | 3.38020 |
| H | −0.08740 | −3.20790 | 2.02930 |
| H | −0.57890 | 1.06280 | 3.31210 |
| H | 0.84350 | 0.07260 | 2.98090 |
| H | −0.30400 | −0.41400 | 4.23780 |
| H | −5.31160 | 3.12500 | −1.95220 |
| H | −7.07110 | 2.94570 | −1.97680 |
| H | −6.03890 | 1.66620 | −2.63240 |
| H | −5.33370 | 3.61580 | 1.14150 |
| H | −6.22120 | 2.50690 | 2.18930 |
| H | −7.09840 | 3.53740 | 1.04990 |
| H | −7.51030 | −0.36260 | −0.71340 |
| H | −8.48850 | 0.96050 | −0.06350 |
| H | −7.53860 | −0.05970 | 1.02640 |
| H | 2.92110 | −0.03430 | −2.81820 |
| H | 1.19620 | 0.24020 | −3.09390 |
| H | 1.80000 | −1.40230 | −2.83340 |
| H | 2.36370 | −3.62520 | −1.26000 |
| H | 1.21780 | −3.65700 | 0.08520 |
| H | 2.84280 | −4.32840 | 0.29030 |
| H | 3.06010 | −0.79950 | 2.69880 |
| H | 3.46080 | −2.51930 | 2.73250 |
| H | 1.77200 | −2.00800 | 2.64980 |
| H | 4.95370 | −1.14490 | −2.60190 |
| H | 6.52440 | −1.86320 | −2.22840 |
| H | 5.08110 | −2.88080 | −2.30310 |
| H | 6.03050 | −2.84990 | 1.88180 |
| H | 7.20330 | −2.91670 | 0.56090 |
| H | 5.78130 | −3.96520 | 0.53190 |
| H | 8.21900 | 1.60170 | 0.18970 |
| H | 8.42120 | −0.14520 | 0.36550 |
| H | 7.87530 | 0.53040 | −1.17490 |
| H | 6.49820 | −0.16730 | 2.85830 |
| H | 6.43280 | 1.59050 | 2.68040 |
| H | 4.93710 | 0.65520 | 2.76210 |
| H | 4.87760 | 1.37250 | −2.84060 |
| H | 6.19670 | 2.49100 | −2.48650 |
| H | 4.57270 | 3.11350 | −2.80320 |
| H | 5.10650 | 3.86180 | 1.39280 |
| H | 4.75430 | 4.70300 | −0.12240 |
| H | 6.36410 | 4.03020 | 0.16020 |
| H | 2.53110 | 1.90100 | 2.35240 |
| H | 0.92650 | 2.40510 | 1.81300 |
| H | 2.26910 | 3.56040 | 1.80070 |
| H | 1.90150 | 2.94700 | −2.40450 |
| H | 1.92170 | 4.23440 | −1.19170 |
| H | 0.52240 | 3.16050 | −1.32410 |

### Molecule 2

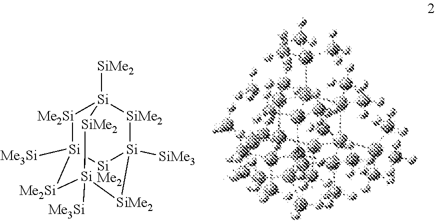

| | | | |
|---|---|---|---|
| Si | −1.71860 | −1.86210 | −1.72230 |
| Si | −4.01700 | −1.50020 | −1.31600 |
| Si | −4.09270 | 0.38020 | 0.09420 |
| C | −4.79950 | −3.04780 | −0.54810 |
| C | −4.91490 | −1.13850 | −2.94900 |
| Si | −2.09320 | 1.47890 | −0.51030 |
| Si | −0.65540 | −0.37850 | −0.22640 |
| C | −1.71140 | 2.90400 | 0.68240 |
| C | −2.17230 | 2.15740 | −2.28070 |
| C | −1.35350 | −1.38910 | −3.52480 |
| C | −1.25590 | −3.68800 | −1.51660 |
| Si | −3.51120 | −0.33560 | 2.25000 |
| Si | −1.24070 | −0.95570 | 1.98770 |
| C | −4.55030 | −1.77040 | 2.92360 |
| C | −3.66870 | 1.08300 | 3.50220 |
| C | −1.06600 | −2.81710 | 2.31780 |
| C | −0.21480 | 0.03420 | 3.24330 |
| Si | −6.07440 | 1.59780 | −0.13280 |
| C | −6.12850 | 2.40820 | −1.83530 |
| C | −6.19180 | 2.94020 | 1.18690 |
| C | −7.54140 | 0.42360 | 0.04580 |
| Si | 1.65120 | −0.14510 | −0.65080 |
| Si | 2.42870 | 2.00850 | −0.14970 |
| Si | 2.90060 | −1.82940 | 0.40850 |
| C | 1.91740 | −0.35820 | −2.53130 |
| Si | 5.17390 | −1.62580 | −0.13990 |
| C | 2.27100 | −3.52060 | −0.17560 |
| C | 2.78120 | −1.77850 | 2.30080 |
| Si | 5.99620 | 0.47850 | 0.48710 |
| C | 5.45650 | −1.90080 | −1.99520 |
| C | 6.13730 | −2.96650 | 0.80040 |
| Si | 4.74950 | 2.21750 | −0.46950 |
| C | 7.79920 | 0.63100 | −0.08920 |
| C | 5.95920 | 0.65280 | 2.37610 |
| C | 5.13110 | 2.30300 | −2.32690 |
| C | 5.29500 | 3.85930 | 0.31620 |
| C | 1.99680 | 2.51610 | 1.62270 |
| C | 1.61230 | 3.20210 | −1.38110 |
| H | −4.16290 | −3.46480 | 0.23570 |
| H | −4.92620 | −3.81810 | −1.31450 |
| H | −5.77910 | −2.83430 | −0.11240 |
| H | −4.47630 | −0.27970 | −3.46360 |
| H | −5.97340 | −0.92380 | −2.77540 |
| H | −4.85300 | −1.99950 | −3.62080 |
| H | −1.55410 | 2.52980 | 1.69700 |
| H | −2.54770 | 3.60870 | 0.71040 |
| H | −0.81530 | 3.45620 | 0.38960 |
| H | −2.73900 | 1.48750 | −2.93180 |
| H | −1.17750 | 2.29030 | −2.71370 |
| H | −2.67540 | 3.12860 | −2.28640 |
| H | −1.44150 | −0.31300 | −3.69030 |
| H | −2.06000 | −1.89090 | −4.19260 |
| H | −0.34450 | −1.69140 | −3.81320 |
| H | −1.36630 | −4.02870 | −0.48480 |
| H | −0.21890 | −3.85710 | −1.81800 |
| H | −1.89540 | −4.31120 | −2.14860 |
| H | −4.44880 | −2.67630 | 2.32490 |
| H | −5.60960 | −1.50030 | 2.94800 |
| H | −4.24040 | −2.00480 | 3.94630 |
| H | −3.27520 | 2.02540 | 3.11600 |
| H | −3.13530 | 0.84350 | 4.42670 |
| H | −4.72080 | 1.24090 | 3.75490 |
| H | −1.82520 | −3.37090 | 1.75860 |
| H | −1.21810 | −3.02940 | 3.38020 |
| H | −0.08740 | −3.20790 | 2.02930 |
| H | −0.57890 | 1.06280 | 3.31210 |
| H | 0.84350 | 0.07260 | 2.98090 |
| H | −0.30400 | −0.41400 | 4.23780 |
| H | −5.31160 | 3.12500 | −1.95220 |
| H | −7.07110 | 2.94570 | −1.97680 |
| H | −6.03890 | 1.66620 | −2.63240 |
| H | −5.33370 | 3.61580 | 1.14150 |
| H | −6.22120 | 2.50690 | 2.18930 |
| H | −7.09840 | 3.53740 | 1.04990 |
| H | −7.51030 | −0.36260 | −0.71340 |
| H | −8.48850 | 0.96050 | −0.06350 |
| H | −7.53860 | −0.05970 | 1.02640 |
| H | 2.92110 | −0.03430 | −2.81820 |
| H | 1.19620 | 0.24020 | −3.09390 |
| H | 1.80000 | −1.40230 | −2.83340 |
| H | 2.36370 | −3.62520 | −1.26000 |
| H | 1.21780 | −3.65700 | 0.08520 |
| H | 2.84280 | −4.32840 | 0.29030 |
| H | 3.06010 | −0.79950 | 2.69880 |
| H | 3.46080 | −2.51930 | 2.73250 |
| H | 1.77200 | −2.00800 | 2.64980 |
| H | 4.95370 | −1.14490 | −2.60190 |
| H | 6.52440 | −1.86320 | −2.22840 |
| H | 5.08110 | −2.88080 | −2.30310 |
| H | 6.03050 | −2.84990 | 1.88180 |
| H | 7.20330 | −2.91670 | 0.56090 |
| H | 5.78130 | −3.96520 | 0.53190 |
| H | 8.21900 | 1.60170 | 0.18970 |
| H | 8.42120 | −0.14520 | 0.36550 |
| H | 7.87530 | 0.53040 | −1.17490 |
| H | 6.49820 | −0.16730 | 2.85830 |
| H | 6.43280 | 1.59050 | 2.68040 |
| H | 4.93710 | 0.65520 | 2.76210 |
| H | 4.87760 | 1.37250 | −2.84060 |
| H | 6.19670 | 2.49100 | −2.48650 |
| H | 4.57270 | 3.11350 | −2.80320 |
| H | 5.10650 | 3.86180 | 1.39280 |
| H | 4.75430 | 4.70300 | −0.12240 |
| H | 6.36410 | 4.03020 | 0.16020 |
| H | 2.53110 | 1.90100 | 2.35240 |
| H | 0.92650 | 2.40510 | 1.81300 |
| H | 2.26910 | 3.56040 | 1.80070 |
| H | 1.90150 | 2.94700 | −2.40450 |
| H | 1.92170 | 4.23440 | −1.19170 |
| H | 0.52240 | 3.16050 | −1.32410 |

### Molecule 7

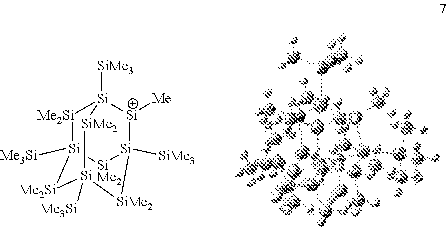

| | | | |
|---|---|---|---|
| Si | −1.25960 | −0.63880 | 2.25800 |
| Si | −2.35360 | 0.06900 | 0.29550 |
| Si | −1.87460 | −1.38540 | −1.47710 |
| Si | 0.45470 | −1.47760 | −1.87410 |
| Si | −4.69580 | 0.11180 | 0.61580 |
| Si | 1.05540 | −2.65680 | −3.83520 |
| C | −1.56360 | 0.61470 | 3.64540 |
| H | −2.60180 | 0.95320 | 3.65690 |
| H | −0.92120 | 1.49150 | 3.54880 |
| H | −1.34890 | 0.15550 | 4.61340 |
| C | −1.92870 | −2.31510 | 2.82740 |
| H | −1.50990 | −2.56840 | 3.80600 |
| H | −1.67310 | −3.12270 | 2.13910 |
| H | −3.01750 | −2.28750 | 2.92940 |
| C | −2.70300 | −0.83170 | −3.08430 |
| H | −2.49960 | −1.54070 | −3.89200 |
| H | −2.36540 | 0.15570 | −3.40520 |
| H | −3.78800 | −0.78820 | −2.94840 |
| C | −2.45580 | −3.14760 | −1.09090 |
| H | −3.49600 | −3.26080 | −1.40680 |
| H | −2.41340 | −3.36690 | −0.02250 |
| H | −1.86340 | −3.89790 | −1.61940 |
| C | −5.40160 | −1.58960 | 0.22550 |
| H | −4.89440 | −2.38210 | 0.78160 |
| H | −5.31770 | −1.81690 | −0.84050 |
| H | −6.46350 | −1.62150 | 0.48710 |
| C | −5.47210 | 1.37980 | −0.54100 |
| H | −6.56190 | 1.34740 | −0.44920 |
| H | −5.22010 | 1.18260 | −1.58630 |
| H | −5.15160 | 2.39670 | −0.29900 |
| C | −5.10260 | 0.57070 | 2.39540 |
| H | −4.71500 | 1.55910 | 2.65600 |
| H | −4.69660 | −0.15340 | 3.10650 |
| H | −6.18830 | 0.59400 | 2.52910 |
| C | −0.15740 | −4.08210 | −4.01430 |
| H | −1.19150 | −3.73470 | −4.07930 |
| H | −0.08480 | −4.77850 | −3.17500 |
| H | 0.06360 | −4.64110 | −4.92850 |
| Si | −1.62410 | 2.23880 | −0.20290 |
| Si | 0.72680 | 2.30250 | −0.41550 |
| Si | 1.32960 | 0.64280 | −1.88310 |
| Si | 1.58850 | 4.37020 | −1.17890 |
| C | −2.16100 | 3.41820 | 1.17160 |
| H | −1.79600 | 4.43270 | 0.99480 |
| H | −1.80950 | 3.09090 | 2.15170 |
| H | −3.25420 | 3.45900 | 1.20800 |
| C | −2.27100 | 2.89750 | −1.85460 |
| H | −3.36140 | 2.84900 | −1.90050 |
| H | −1.87090 | 2.33370 | −2.70050 |
| H | −1.97790 | 3.94430 | −1.98110 |
| C | 2.87970 | 0.91060 | −2.89800 |
| H | 2.57550 | 1.19870 | −3.91200 |
| H | 3.46740 | −0.00670 | −2.98590 |
| H | 3.50240 | 1.71320 | −2.49820 |
| C | 1.38420 | 4.44670 | −3.04780 |
| H | 0.34990 | 4.25570 | −3.34520 |
| H | 2.02660 | 3.72100 | −3.55320 |
| H | 1.65860 | 5.43980 | −3.41560 |
| C | 3.39890 | 4.57220 | −0.71490 |
| H | 3.76310 | 5.53500 | −1.08620 |
| H | 4.02990 | 3.79190 | −1.14680 |
| H | 3.53870 | 4.56270 | 0.36880 |
| C | 0.56320 | 5.71650 | −0.36090 |
| H | 0.59090 | 5.63930 | 0.72910 |
| H | −0.48130 | 5.67330 | −0.67960 |
| H | 0.95290 | 6.70080 | −0.63670 |
| C | 0.89740 | −1.48550 | −5.29870 |
| H | 1.65120 | −0.69500 | −5.26440 |
| H | −0.09010 | −1.01780 | −5.33150 |
| H | 1.03860 | −2.03290 | −6.23530 |
| Si | 1.94530 | 1.31000 | 1.39420 |
| Si | 1.06340 | −0.80570 | 1.91370 |
| Si | 1.54950 | −2.23960 | 0.12110 |
| Si | 2.15270 | −1.60670 | 3.85330 |
| C | 1.81590 | 2.54210 | 2.82290 |
| H | 2.25080 | 2.12070 | 3.73400 |
| H | 0.78330 | 2.82240 | 3.03680 |
| H | 2.36880 | 3.45300 | 2.57730 |
| C | 3.76170 | 1.21270 | 0.86610 |
| H | 4.17250 | 2.21950 | 0.75630 |
| H | 3.90300 | 0.69290 | −0.08430 |
| H | 4.35380 | 0.68850 | 1.62010 |
| C | 0.84430 | −3.97930 | 0.34580 |
| H | 1.07410 | −4.59090 | −0.53200 |
| H | −0.23800 | −3.97170 | 0.47840 |
| H | 1.29350 | −4.46050 | 1.21810 |
| C | 3.41290 | −2.40340 | −0.15200 |
| H | 3.89170 | −2.70980 | 0.78350 |
| H | 3.88700 | −1.47500 | −0.47500 |
| H | 3.62620 | −3.17050 | −0.89970 |
| C | 3.93180 | −0.98990 | 3.89930 |
| H | 3.98060 | 0.10100 | 3.95540 |
| H | 4.49730 | −1.31260 | 3.02130 |
| H | 4.43710 | −1.38820 | 4.78430 |
| C | 2.14620 | −3.48910 | 3.84110 |
| H | 2.54680 | −3.86970 | 4.78540 |
| H | 2.76900 | −3.88720 | 3.03540 |
| H | 1.13560 | −3.88870 | 3.72150 |
| C | 1.24080 | −0.98530 | 5.37770 |
| H | 0.24480 | −1.42880 | 5.45370 |
| H | 1.12810 | 0.10190 | 5.37280 |
| H | 1.79550 | −1.26150 | 6.27950 |
| C | 2.80560 | −3.33050 | −3.71180 |
| H | 2.87150 | −4.11070 | −2.94950 |
| H | 3.53890 | −2.55750 | −3.47050 |
| H | 3.09520 | −3.77800 | −4.66730 |

### Molecule 8

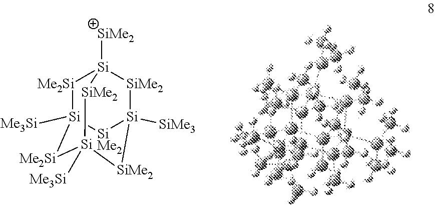

| | | | |
|---|---|---|---|
| Si | −0.94550 | 2.27420 | −1.13360 |
| Si | −1.68210 | 1.37460 | 0.90820 |
| Si | 0.12870 | 1.25210 | 2.40100 |
| Si | 1.81060 | −0.11990 | 1.49940 |
| Si | −3.36450 | 2.74760 | 1.81350 |
| Si | 3.62030 | −0.23800 | 2.99800 |
| C | −2.49700 | 2.43330 | −2.21690 |
| H | −3.11270 | 3.25510 | −1.83600 |
| H | −3.10480 | 1.52630 | −2.18350 |
| H | −2.25540 | 2.64960 | −3.26000 |
| C | −0.17810 | 4.00520 | −0.99390 |
| H | −0.07990 | 4.43140 | −1.99800 |
| H | 0.82170 | 3.96710 | −0.55530 |
| H | −0.79140 | 4.68520 | −0.39830 |
| C | −0.30200 | 0.49910 | 4.09030 |
| H | 0.52210 | 0.69180 | 4.78550 |
| H | −0.43000 | −0.58390 | 4.02660 |
| H | −1.21010 | 0.93020 | 4.51780 |
| C | 0.66620 | 3.04730 | 2.70760 |
| H | −0.08560 | 3.54080 | 3.33260 |
| H | 0.73670 | 3.61050 | 1.77420 |
| H | 1.62690 | 3.11150 | 3.22360 |
| C | −2.99800 | 4.56800 | 1.47130 |
| H | −3.04710 | 4.78730 | 0.40130 |
| H | −2.00410 | 4.85050 | 1.82880 |
| H | −3.73280 | 5.20240 | 1.97650 |
| C | −3.48570 | 2.51070 | 3.68280 |
| H | −4.33190 | 3.07910 | 4.08120 |
| H | −2.58070 | 2.86180 | 4.18580 |
| H | −3.63140 | 1.45910 | 3.94440 |
| C | −5.04330 | 2.33150 | 1.05650 |
| H | −5.36460 | 1.32450 | 1.33600 |
| H | −5.01490 | 2.38640 | −0.03510 |
| H | −5.80240 | 3.03540 | 1.41150 |
| C | 3.88520 | 1.42200 | 3.85800 |
| H | 3.04060 | 1.67130 | 4.50590 |
| H | 4.00710 | 2.23280 | 3.13470 |
| H | 4.78470 | 1.38530 | 4.48040 |
| Si | −2.53850 | −0.78320 | 0.54410 |
| Si | −0.86290 | −2.16000 | −0.36140 |
| Si | 0.94520 | −2.27380 | 1.13520 |
| Si | −1.72510 | −4.31860 | −0.72410 |
| C | −3.98260 | −0.85490 | −0.68670 |
| H | −4.45640 | −1.84020 | −0.62010 |
| H | −3.63980 | −0.72580 | −1.71590 |
| H | −4.74470 | −0.10050 | −0.47880 |
| C | −3.20320 | −1.36510 | 2.22500 |
| H | −4.12060 | −0.81270 | 2.45450 |
| H | −2.49140 | −1.16600 | 3.02940 |
| H | −3.44210 | −2.43090 | 2.23060 |
| C | 2.40620 | −3.31830 | 0.51830 |
| H | 3.08740 | −3.50480 | 1.35550 |
| H | 2.97410 | −2.79720 | −0.25590 |
| H | 2.08780 | −4.28520 | 0.12220 |
| C | 0.27160 | −3.11830 | 2.69680 |
| H | 0.11010 | −4.18060 | 2.48440 |
| H | −0.68900 | −2.69530 | 2.99980 |
| H | 0.96300 | −3.04520 | 3.53920 |
| C | −2.93360 | −4.79490 | 0.64620 |
| H | −3.82500 | −4.16230 | 0.62510 |
| H | −2.47600 | −4.70110 | 1.63480 |
| H | −3.25700 | −5.83280 | 0.52010 |
| C | −0.33570 | −5.59660 | −0.75530 |
| H | −0.73430 | −6.58110 | −1.01920 |
| H | 0.14520 | −5.68220 | 0.22280 |
| H | 0.43270 | −5.33530 | −1.48790 |
| C | −2.64090 | −4.40280 | −2.37330 |
| H | −1.95550 | −4.26330 | −3.21360 |
| H | −3.41780 | −3.63630 | −2.44010 |
| H | −3.11870 | −5.38050 | −2.49030 |
| C | 3.30650 | −1.54490 | 4.32410 |
| H | 3.27480 | −2.54840 | 3.89120 |
| H | 2.35970 | −1.37070 | 4.84240 |
| H | 4.10840 | −1.52710 | 5.06870 |
| Si | −0.12740 | −1.25280 | −2.40030 |
| Si | 0.73330 | 0.90500 | −2.04440 |
| Si | 2.53790 | 0.78290 | −0.54440 |
| Si | 1.46730 | 1.80960 | −4.08810 |
| C | −1.49180 | −1.05520 | −3.70620 |
| H | −1.02680 | −0.85000 | −4.67640 |
| H | −2.15050 | −0.21500 | −3.47470 |
| H | −2.10230 | −1.95520 | −3.80980 |
| C | 1.13550 | −2.49160 | −3.09030 |
| H | 0.60430 | −3.38310 | −3.44010 |
| H | 1.84330 | −2.81240 | −2.32250 |
| H | 1.69960 | −2.08420 | −3.93230 |
| C | 3.31490 | 2.46250 | −0.11870 |
| H | 4.27110 | 2.29310 | 0.38780 |
| H | 2.68160 | 3.03700 | 0.56120 |
| H | 3.50770 | 3.06840 | −1.00680 |
| C | 3.86970 | −0.24530 | −1.42390 |
| H | 4.30490 | 0.35400 | −2.23070 |
| H | 3.44850 | −1.14610 | −1.87590 |
| H | 4.67770 | −0.54130 | −0.75110 |
| C | 2.24330 | 0.47100 | −5.17050 |
| H | 1.49950 | −0.26860 | −5.47910 |
| H | 3.04480 | −0.05480 | −4.64460 |
| H | 2.66750 | 0.91640 | −6.07580 |
| C | 2.76000 | 3.15470 | −3.79660 |
| H | 3.02540 | 3.63480 | −4.74360 |
| H | 3.67440 | 2.73790 | −3.36580 |
| H | 2.38830 | 3.92720 | −3.11800 |
| C | 0.02470 | 2.57370 | −5.03680 |
| H | −0.37930 | 3.44220 | −4.50990 |
| H | −0.78780 | 1.85580 | −5.17730 |
| H | 0.35680 | 2.90690 | −6.02500 |
| C | 5.21150 | −0.69060 | 2.08800 |
| H | 5.51070 | 0.10200 | 1.39700 |
| H | 5.09600 | −1.61380 | 1.51360 |
| H | 6.02720 | −0.83630 | 2.80300 |

### Molecule 18

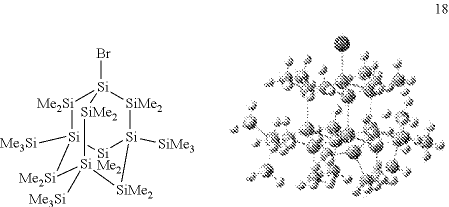

| | | | |
|---|---|---|---|
| Si | 2.05600 | 0.81730 | −1.43240 |
| Si | 1.75360 | −1.38870 | −0.65970 |
| Si | −0.32010 | −2.18560 | −1.43720 |
| Si | −2.07950 | −0.82300 | −0.66050 |
| Si | 3.50700 | −2.74560 | −1.44300 |
| Si | −4.13290 | −1.65860 | −1.44450 |
| C | 3.79190 | 1.35470 | −0.87400 |
| H | 4.54140 | 0.77410 | −1.42470 |
| H | 3.95320 | 1.17140 | 0.19180 |
| H | 3.97490 | 2.41460 | −1.07260 |
| C | 2.02400 | 0.97200 | −3.32840 |
| H | 2.40010 | 1.96340 | −3.60790 |
| H | 1.00920 | 0.88250 | −3.72660 |
| H | 2.65460 | 0.22370 | −3.81700 |
| C | −0.72270 | −3.95840 | −0.88130 |
| H | −1.60010 | −4.31660 | −1.43260 |
| H | −0.96250 | −4.00700 | 0.18430 |
| H | 0.10360 | −4.64690 | −1.08010 |
| C | −0.17100 | −2.23270 | −3.33340 |
| H | 0.50250 | −3.05120 | −3.61440 |
| H | 0.25480 | −1.30690 | −3.73060 |
| H | −1.13410 | −2.40810 | −3.82140 |
| C | 4.05340 | −2.22020 | −3.17520 |
| H | 4.47560 | −1.21020 | −3.16960 |
| H | 3.21320 | −2.23100 | −3.87680 |
| H | 4.82150 | −2.90200 | −3.55590 |
| C | 2.96830 | −4.55690 | −1.51080 |
| H | 3.81570 | −5.19850 | −1.77500 |
| H | 2.18630 | −4.70950 | −2.26150 |
| H | 2.57870 | −4.89120 | −0.54390 |
| C | 4.98400 | −2.60820 | −0.27060 |
| H | 4.74340 | −3.03810 | 0.70740 |
| H | 5.27720 | −1.56510 | −0.11550 |
| H | 5.84790 | −3.14940 | −0.67100 |
| C | −3.95370 | −2.39150 | −3.17840 |
| H | −3.29140 | −3.26320 | −3.17440 |
| H | −3.54240 | −1.65820 | −3.87940 |
| H | −4.92880 | −2.71390 | −3.55900 |
| Si | 1.76700 | −1.38440 | 1.68990 |
| Si | −0.00210 | −0.00320 | 2.34100 |
| Si | −2.08200 | −0.84370 | 1.68890 |
| C | 3.32070 | −0.67500 | 2.51150 |
| H | 3.16610 | −0.68040 | 3.59620 |
| H | 3.50920 | 0.35880 | 2.21250 |
| H | 4.21020 | −1.26920 | 2.28490 |
| C | 1.53960 | −3.15190 | 2.33870 |
| H | 2.48350 | −3.70190 | 2.25490 |
| H | 0.78190 | −3.70070 | 1.77280 |
| H | 1.24560 | −3.13890 | 3.39330 |
| C | −3.49880 | 0.23580 | 2.34050 |
| H | −4.44790 | −0.30480 | 2.25390 |
| H | −3.59320 | 1.16850 | 1.77760 |
| H | −3.34120 | 0.48020 | 3.39600 |
| C | −2.24380 | −2.54650 | 2.50540 |
| H | −2.17590 | −2.41240 | 3.59080 |
| H | −1.43950 | −3.22360 | 2.20800 |
| H | −3.20080 | −3.02190 | 2.27380 |
| C | −4.75330 | −3.00880 | −0.27490 |
| H | −5.00350 | −2.58790 | 0.70450 |
| H | −3.99740 | −3.78590 | −0.12310 |
| H | −5.65500 | −3.48390 | −0.67550 |
| Si | 0.31240 | 2.21970 | 1.69320 |
| Si | 0.32800 | 2.21400 | −0.65640 |
| Si | −1.73180 | 1.37280 | −1.43260 |
| Si | 0.62750 | 4.41200 | −1.43700 |
| C | 1.95640 | 2.90330 | 2.34620 |
| H | 1.96290 | 3.99580 | 2.26270 |
| H | 2.81110 | 2.52000 | 1.78210 |
| H | 2.08950 | 2.64160 | 3.40100 |
| C | −1.07900 | 3.21310 | 2.51210 |
| H | −0.99700 | 3.08530 | 3.59720 |
| H | −2.06890 | 2.85910 | 2.21420 |
| H | −1.00890 | 4.27990 | 2.28220 |
| C | −1.84960 | 1.26840 | −3.32860 |
| H | −2.89620 | 1.09680 | −3.60740 |
| H | −1.26390 | 0.43470 | −3.72650 |
| H | −1.51810 | 2.18870 | −3.81780 |
| C | −3.06520 | 2.60700 | −0.87420 |
| H | −2.93590 | 3.54760 | −1.42250 |
| H | −2.98810 | 2.83570 | 0.19220 |
| H | −4.07460 | 2.23660 | −1.07510 |
| C | −0.23120 | 5.62130 | −0.26420 |
| H | 0.25890 | 5.62600 | 0.71490 |
| H | −1.28180 | 5.35390 | −0.11240 |
| H | −0.19290 | 6.64070 | −0.66290 |
| C | −0.10030 | 4.62430 | −3.16920 |
| H | 0.10420 | 5.63130 | −3.54850 |
| H | −1.18580 | 4.48300 | −3.16370 |
| H | 0.33030 | 3.90390 | −3.87200 |
| C | 2.46560 | 4.85070 | −1.50280 |
| H | 2.98970 | 4.24990 | −2.25290 |
| H | 2.94850 | 4.68000 | −0.53530 |
| H | 2.59840 | 5.90540 | −1.76650 |
| C | −5.43110 | −0.28530 | −1.50860 |
| H | −5.17240 | 0.46990 | −2.25770 |
| H | −5.52540 | 0.21730 | −0.54070 |
| H | −6.41080 | −0.69740 | −1.77330 |
| Br | −0.00220 | −0.00510 | 4.62230 |

### III. Crystallographic Data

### Molecule 3

### Data Collection

Single crystals suitable for X-ray diffraction were grown by methanol/toluene. A colorless crystal (block, approximate dimensions 0.308×0.144×0.094 mm³) was placed onto the tip of a MiTeGen pin and mounted on a Bruker Venture D8 diffractometer equipped with a PhotonIII detector at 100.00 K. The data collection was carried out using Mo Ka radiation (1=0.71073 Å, graphite monochromator) with a frame time of 2 seconds and a detector distance of 40 mm. A collection strategy was calculated and complete data to a resolution of 0.57 Å with a redundancy of 14.2 were collected. The frames were integrated with the Bruker SAINT¹ software package using a narrow-frame algorithm to 0.65 Å resolution. Data were corrected for absorption effects using the Multi-Scan method (SADABS).² The ratio of minimum to maximum apparent transmission was 0.940. Please refer to Table S2 for additional crystal and refinement information.

### Structure Solution and Refinement

The space group P-1 was determined based on intensity statistics and systematic absences. The structure was solved using the SHELX suite of programs³ and refined using full-matrix least-squares on F² within the OLEX2 suite.⁴ An intrinsic phasing solution was calculated, which provided most non-hydrogen atoms from the E-map. Full-matrix least squares/difference Fourier cycles were performed, which located the remaining non-hydrogen atoms. All non-hydrogen atoms were refined with anisotropic displacement parameters. The hydrogen atoms were placed in ideal positions and refined as riding atoms with relative isotropic displacement parameters. The final full matrix least squares refinement converged to R1=0.0365 and wR2=0.0881 (F², all data). The goodness-of-fit was 1.043. On the basis of the final model, the calculated density was 1.114 g/cm³ and F(000), 890 e⁻. The chlorine atom is disordered over 12 positions.

TABLE S2
Crystal data and structure refinement for 3.

| Empirical formula | C26.50 H73 C1 Si14 | |
|---|---|---|
| Formula weight | 820.55 | |
| Crystal color, shape, size | colorless block, | |
| | 0.308 × 0.144 × 0.094 mm³ | |
| Temperature | 100.00 K | |
| Wavelength | 0.71073 Å | |
| Crystal system, space group | Triclinic, P-1 | |
| Unit cell dimensions | a = 12.6510(6) Å | a = 75.934(2)°. |
| | b = 14.1174(8) Å | b = 87.260(2)°. |
| | c = 14.1398(8) Å | g = 87.483(2)°. |

| | |
|---|---|
| Volume | 2445.5(2) Å³ |
| Z | 2 |
| Density (calculated) | 1.114 g/cm³ |
| Absorption coefficient | 0.439 mm⁻¹ |
| F(000) | 890 |
| Data collection | |
| Diffractometer | BRUKER D8 VENTURE |
| Theta range for data collection | 2.151 to 33.141°. |
| Index ranges | −19 <= h <= 19, −21 <= k <= 21, |
| | −21 <= l <= 21 |
| Reflections collected | 197904 |
| Independent reflections | 18666 [Rint = 0.0635] |
| Observed Reflections | 13459 |
| Completeness to theta = 25.242° | 99.9% |
| Solution and Refinement | |
| Absorption correction | Semi-empirical from equivalents |
| Max. and min. transmission | 0.7465 and 0.7124 |
| Solution | Intrinsic methods |
| Refinement method | Full-matrix least-squares on F² |
| Weighting scheme | w = [s²Fo² + AP² + BP]⁻¹, with |
| | P = (Fo² + 2 Fc²)/3, A = 0.0294, |
| | B = 1.0513 |
| Data/restraints/parameters | 18666/728/432 |
| Goodness-of-fit on F² | 1.043 |
| Final R indices [I > 2s(I)] | R1 = 0.0365, wR2 = 0.0795 |
| R indices (all data) | R1 = 0.0615, wR2 = 0.0881 |
| Largest diff. peak and hole | 0.971 and −1.083 e.Å⁻³ |

### Molecule 4

### Data Collection

Single crystals suitable for X-ray diffraction were grown by vapor diffusion of toluene into a methanol solution. A colorless crystal (block, approximate dimensions 0.22×0.11×0.09 mm³) was placed onto the tip of a MiTeGen pin and mounted on a Bruker Venture D8 diffractometer equipped with a PhotonIII detector at 123.00 K. The data collection was carried out using Mo Ka radiation (1=0.71073 Å, graphite monochromator) with a frame time of 10 seconds for dynamic scans and 2 seconds for photon counting. The detector distance was 40 mm. A collection strategy was calculated and complete data to a resolution of 0.80 Å with a redundancy of 6.5 were collected. The frames were integrated with the Bruker SAINT¹ software package using a narrow-frame algorithm to 0.80 Å resolution. Data were corrected for absorption effects using the Multi-Scan method (SADABS).² Please refer to Table S3 for additional crystal and refinement information.

### Structure Solution and Refinement

The space group P-1 was determined based on intensity statistics and systematic absences. The structure was solved using the SHELX suite of programs³ and refined using full-matrix least-squares on F² within the OLEX2 suite.⁴ An intrinsic phasing solution was calculated, which provided most non-hydrogen atoms from the E-map. Full-matrix least squares/difference Fourier cycles were performed, which located the remaining non-hydrogen atoms. All non-hydrogen atoms were refined with anisotropic displacement parameters. The hydrogen atoms were placed in ideal positions and refined as riding atoms with relative isotropic displacement parameters. The final full matrix least squares refinement converged to R1=0.0766 and wR2=0.2098 (F², all data). The goodness-of-fit was 1.051. On the basis of the final model, the calculated density was 1.168 g/cm³ and F(000), 810 e⁻. Disorder was modeled for all the —CH₂—S— CH₃ groups, with occupancy distributed among 2, 3, and 4 sites. Restraints on bond lengths and constraints on the atomic displacement parameters were employed to model the disorder.

TABLE S3
Crystal data and structure refinement for 4.

| Empirical formula | C47 H120 S8 Si20 | |
|---|---|---|
| Formula weight | 1503.70 | |
| Crystal color, shape, size | colorless block, | |
| | 0.22 × 0.11 × 0.09 mm³ | |
| Temperature | 123.00 K | |
| Wavelength | 0.71073 Å | |
| Crystal system, space group | Triclinic, P-1 | |
| Unit cell dimensions | a = 11.1135(5) Å | α = 74.428(2)°. |
| | b = 11.1106(5) Å | β = 74.428(2)°. |
| | c = 18.8033(8) Å | γ = 79.140(2)°. |

| | |
|---|---|
| Volume | 2137.47(17) Å³ |
| Z | 1 |
| Density (calculated) | 1.168 g/cm³ |
| Absorption coefficient | 0.518 mm⁻¹ |
| F(000) | 810 |
| Data collection | |
| Diffractometer | BRUKER D8 VENTURE |
| Theta range for data collection | 1.917 to 26.372°. |
| Index ranges | −13 <= h <= 13, −13 <− k <= 13, |
| | −23 <= l <= 23 |
| Reflections collected | 81877 |
| Independent reflections | 8744 [Rint = 0.0527] |
| Observed Reflections | 6632 |
| Completeness to theta = 25.242° | 100.0% |
| Solution and Refinement | |
| Absorption correction | Semi-empirical from equivalents |
| Max. and min. transmission | 0.7454 and 0.7131 |
| Solution | Intrinsic methods |
| Refinement method | Full-matrix least-squares on F² |
| Weighting scheme | w = [σ²Fo² + AP² + BP]⁻¹, with |
| | P = (Fo² + 2 Fc²)/3, A = 0.083, |
| | B = 4.13 |
| Data/restraints/parameters | 8744/363/415 |
| Goodness-of-fit on F² | 1.051 |
| Final R indices [I > 2σ(I)] | R1 = 0.0766, wR2 = 0.1906 |
| R indices (all data) | R1 = 0.0974, wR2 = 0.2098 |
| Largest diff. peak and hole | 1.081 and −0.749 e.Å⁻³ |

### Molecule 5

### Data Collection

Single crystals suitable for X-ray diffraction were grown by vapor diffusion of vapor into a THF solution. A colorless crystal (block, approximate dimensions 0.24×0.14×0.05 mm³) was placed onto the tip of a MiTeGen pin and mounted on a Bruker Venture D8 diffractometer equipped with a PhotonIII detector at 140.00 K. The data collection was carried out using Mo Ka radiation (1=0.71073 Å, graphite monochromator) with a frame time of 4 seconds and a detector distance of 50 mm. A collection strategy was calculated and complete data to a resolution of 0.80 Å with a redundancy of 6.3 were collected. The frames were integrated with the Bruker SAINT¹ software package using a narrow-frame algorithm to 0.84 Å resolution. Data were corrected for absorption effects using the Multi-Scan method (SADABS).² The ratio of minimum to maximum apparent transmission was 0.931. The calculated minimum and maximum transmission coefficients (based on crystal size) are 0.7450 and 0.9380. Please refer to Table S4 for additional crystal and refinement information.

### Structure Solution and Refinement

The space group P 1 21/n 1 was determined based on intensity statistics and systematic absences. The structure was solved using the SHELX suite of programs³ and refined using full-matrix least-squares on F² within the OLEX2 suite.⁴ An intrinsic phasing solution was calculated, which provided most non-hydrogen atoms from the E-map. Full-matrix least squares/difference Fourier cycles were performed, which located the remaining non-hydrogen atoms. All non-hydrogen atoms were refined with anisotropic displacement parameters. The hydrogen atoms were placed in ideal positions and refined as riding atoms with relative isotropic displacement parameters. The final full matrix least squares refinement converged to R1=0.0612 and wR2=0.1682 (F², all data). The goodness-of-fit was 0.997. On the basis of the final model, the calculated density was 1.176 g/cm³ and F(000), 3312 e⁻.

TABLE S4
Crystal data and structure refinement for 5.

| Empirical formula | C24 H65 Br S Si11 | |
|---|---|---|
| Formula weight | 774.72 | |
| Crystal color, shape, size | colorless block, | |
| | 0.24 × 0.14 × 0.05 mm³ | |
| Temperature | 140.00 K | |
| Wavelength | 0.71073 Å | |
| Crystal system, space group | Monoclinic, P 1 21/n 1 | |
| Unit cell dimensions | a = 22.6814(19) Å | a = 90°. |
| | b = 17.1551(15) Å | b = 103.269(2)°. |
| | c = 23.1040(17) Å | g = 90°. |

| | |
|---|---|
| Volume | 8749.8(12) Å³ |
| Z | 8 |
| Density (calculated) | 1.176 g/cm³ |
| Absorption coefficient | 1.304 mm⁻¹ |
| F(000) | 3312 |
| Data collection | |
| Diffractometer | BRUKER D8 VENTURE |
| Theta range for data collection | 1.493 to 25.024°. |
| Index ranges | −26 <= h <= 26, −20 <= k <= 20, |
| | −27 <= l <= 27 |
| Reflections collected | 263500 |
| Independent reflections | 15444 [Rint = 0.2283] |
| Observed Reflections | 8752 |
| Completeness to theta = 25.024° | 100.0% |
| Solution and Refinement | |
| Absorption correction | Semi-empirical from equivalents |
| Max. and min. transmission | 0.7335 and 0.6826 |
| Solution | Intrinsic methods |
| Refinement method | Full-matrix least-squares on F² |
| Weighting scheme | w = [s²Fo² + AP² + BP]⁻¹, with |
| | P = (Fo² + 2 Fc²)/3, A = 0.0559, |
| | B = 26.787201 |
| Data/restraints/parameters | 15444/697/726 |
| Goodness-of-fit on F² | 0.997 |
| Final R indices [I > 2s(I)] | R1 = 0.0612, wR2 = 0.1314 |
| R indices (all data) | R1 = 0.1362, wR2 = 0.1682 |
| Largest diff. peak and hole | 1.482 and −0.778 e.Å⁻³ |

### Molecule 22

### Data Collection

Single crystals suitable for X-ray diffraction were grown by vapor diffusion of pentane into THF. An orange crystal (block, approximate dimensions 0.25×0.24×0.17 mm³) was placed onto the tip of a MiTeGen pin and mounted on a Bruker Venture D8 diffractometer equipped with a PhotonIII detector at 140.00 K. The data collection was carried out using Mo Ka radiation (1=0.71073 Å, graphite monochromator) with a frame time of 2 seconds and a detector distance of 50 mm. A collection strategy was calculated and complete data to a resolution of 0.80 Å with a redundancy of 4.5 were collected. The frames were integrated with the Bruker SAINT¹ software package using a narrow-frame algorithm to 0.84 Å resolution. Data were corrected for absorption effects using the Multi-Scan method (SADABS).² Please refer to Table S5 for additional crystal and refinement information.

### Structure Solution and Refinement

The space group P-1 was determined based on intensity statistics and systematic absences. The structure was solved using the SHELX suite of programs³ and refined using full-matrix least-squares on F² within the OLEX2 suite.⁴ An intrinsic phasing solution was calculated, which provided most non-hydrogen atoms from the E-map. Full-matrix least squares/difference Fourier cycles were performed, which located the remaining non-hydrogen atoms. All non-hydrogen atoms were refined with anisotropic displacement parameters. The hydrogen atoms were placed in ideal positions and refined as riding atoms with relative isotropic displacement parameters. The final full matrix least squares refinement converged to R1=0.1487 and wR2=0.4517 (F², all data). The goodness-of-fit was 1.668. On the basis of the final model, the calculated density was 1.165 g/cm³ and F(000), 1348 e⁻. The structure suffers from poor data quality, with intensity dropping significantly at high resolution. Disorder was modeled for the two crown ethers and for co-crystalized pentane.

TABLE S5
Crystal data and structure refinement for 22.

| Empirical formula | C45 H102 K2 O12 Si12 | |
|---|---|---|
| Formula weight | 1250.54 | |
| Crystal color, shape, size | orange block, | |
| | 0.25 × 0.24 × 0.17 mm³ | |
| Temperature | 140.00 K | |
| Wavelength | 0.71073 Å | |
| Crystal system, space group | Triclinic, P-1 | |
| Unit cell dimensions | a = 12.449(2) Å | a = 94.931(5)°. |
| | b = 13.202(2) Å | b = 97.060(5)°. |
| | c = 22.378(4) Å | g = 100.698(5)°. |

| | |
|---|---|
| Volume | 3564.2(11) Å³ |
| Z | 2 |
| Density (calculated) | 1.165 g/cm³ |
| Absorption coefficient | 0.381 mm⁻¹ |
| F(000) | 1348 |
| Data collection | |
| Diffractometer | BRUKER D8 VENTURE |
| Theta range for data collection | 1.580 to 25.028°. |
| Index ranges | −14 <= h <= 14, −15 <= k <= 15, |
| | −26 <= l <= 26 |
| Reflections collected | 139415 |
| Independent reflections | 12589 [Rint = 0.1948] |
| Observed Reflections | 8824 |
| Completeness to theta = 25.028° | 100.0% |
| Solution and Refinement | |
| Absorption correction | Semi-empirical from equivalents |
| Max. and min. transmission | 0.7452 and 0.6204 |
| Solution | Intrinsic methods |
| Refinement method | Full-matrix least-squares on F² |
| Weighting scheme | W = [s²Fo² + AP² + BP]⁻¹, with |
| | P = (Fo² + 2 Fc²)/3, A = 0.20, |
| | B = 0.00 |
| Data/restraints/parameters | 12589/1315/550 |
| Goodness-of-fit on F² | 1.668 |
| Final R indices [I > 2s(I)] | R1 = 0.1487, wR2 = 0.4245 |
| R indices (all data) | R1 = 0.1843, wR2 = 0.4517 |
| Largest diff. peak and hole | 1.966 and −0.786 e.Å⁻³ |

### Crystallography References:

¹SAINT, V8.30A, Bruker Analytical X-Ray Systems, Madison, WI, 2012.
²SADABS, 2.03, Bruker Analytical X-Ray Systems, Madison, WI, 2016.
³G. M. Sheldrick, Acta Cryst. A64, 112-122 (2008). Sheldrick, G. M. (2015). Acta Cryst. A71, 3-8.
⁴O. V. Dolomanov, L. J. Bourhis, R. J. Gildea, J. A. K. Howard and H. Puschmann, J. Appl. Crystallogr., 2009, 42, 339-341.

What is claimed is:

1. A sila-adamantane material comprising:
a base adamantane cluster of silicon atoms;
ten silicon locations about the base adamantane cluster;
a functional molecule attached to one or more of the ten silicon locations; and
methyl molecules at non-functional silicon locations.

2. The sila-adamantane material of claim 1, wherein the functional molecule includes a halide.

3. The sila-adamantane material of claim 2, wherein the functional molecule is SiMe₂Cl.

4. The sila-adamantane material of claim 1, wherein the functional molecule is attached at the second of ten silicon locations.

5. The sila-adamantane material of claim 1, wherein four functional molecules are attached at four selected locations of the ten silicon locations.

6. The sila-adamantane material of claim 5, wherein the four functional molecules are attached at the first, third, fifth and seventh of ten silicon locations.

7. The sila-adamantane material of claim 6, wherein the four functional molecules are the same.

8. The sila-adamantane material of claim 6, wherein the four functional molecules are each different from one another.

9. An electronic device, comprising:
an electronic component including a plurality of assembled sila-adamantane molecules, each sila-adamantane molecule including;
a base adamantane cluster of silicon atoms;
ten silicon locations about the base adamantane cluster;
a functional molecule attached to one or more of the ten silicon locations; and
methyl molecules at non-functional silicon locations.

10. The electronic device of claim 9, wherein the electronic component is part of a battery electrode.

11. The electronic device of claim 9, wherein the electronic component is part of a light emitting device.

12. The electronic device of claim 9, wherein the electronic component is part of circuitry in a computing device.

13. A method, comprising:
reacting silane molecules to produce a sila-adamantane molecule;
selecting a functional molecule location from ten silicon locations about a base adamantane cluster on the sila-adamantane molecule; and
bonding a functional molecule at the functional location to form a functionalized sila-adamantane molecule.

14. The method of claim 13, wherein bonding a functional molecule at the functional location includes bonding at a second location of the ten silicon locations.

15. The method of claim 13, wherein bonding a functional molecule at the functional location includes bonding four functional molecules at four locations of the ten silicon locations.

16. The method of claim 15, wherein bonding four functional molecules at four locations of the ten silicon locations includes bonding at a first, third, fifth and seventh of the ten silicon locations.

17. The method of claim 16, wherein bonding four functional molecules includes bonding four of the same molecule.

18. The method of claim 16, wherein bonding four functional molecules includes bonding four different molecules.

19. The method of claim 16, wherein bonding four functional molecules includes sequential functional molecule attachment.

20. The method of claim 13, wherein the method is performed as a single pot reaction.

21. The method of claim 13, further including utilizing the functionalized sila-adamantane molecule as a ligand in a catalytic reaction.
